(19) United States
(12) Patent Application Publication
(10) Pub. No.: US 2012/0198186 A1
(43) Pub. Date: Aug. 2, 2012

(54) MEMORY DEVICE AND MEMORY SYSTEM

(75) Inventors: Junichi Koshiyama, Tokyo (JP); Tamaki Konno, Kanagawa (JP); Daisuke Nakajima, Tokyo (JP); Toshifumi Nishiura, Tokyo (JP)

(73) Assignee: Sony Corporation, Tokyo (JP)

(21) Appl. No.: 13/340,981

(22) Filed: Dec. 30, 2011

(30) Foreign Application Priority Data
Jan. 30, 2011 (JP) 2011-018909

(51) Int. Cl. G06F 12/02

(52) U.S. Cl. 711/159; 711/E12.002

(57) ABSTRACT

A memory device includes a plurality of nonvolatile memories configured to be erased at updating of data, and a memory controller configured to control the nonvolatile memory. The memory controller includes an address conversion table configured to convert a logical address specified by at data writing into a physical address of the nonvolatile memory, an erased physical block managing unit configured to manage an erased physical block address, the nonvolatile memory of the erased physical block address, and an erased physical block count on each nonvolatile memory, an erasable physical block managing unit configured to manage an erasable physical block address, the nonvolatile memory of the erasable physical block address, and an erasable physical block count on each nonvolatile memory, and a memory control unit configured to control writing and erasing on the plurality of nonvolatile memories.

### CROSS REFERENCES TO RELATED APPLICATIONS

The present application claims priority to Japanese Priority Patent Application JP 2011-018909 filed in the Japan Patent Office on Jan. 31, 2011, the entire content of which is hereby incorporated by reference.

### BACKGROUND

The present disclosure relates to a memory device, such as a flash memory, which erases data thereon before updating data, and relates to a memory system.

A flash memory as one type of nonvolatile memory is widely used in a memory card and a universal serial bus (USB) drive.

The flash memory undergoes an erase operation before data is written thereon. As illustrated in FIG. 1, data writing is performed by write unit (page unit) PG, and data erasing is performed by block BLK unit. Each block is a set of pages. As illustrated in FIG. 1, one BLK includes a set of 128 pages.

International Publication No. WO2005/029311 describes a memory system that includes a logical-physical converter. In the logical-physical converter, a memory controller converts a logical address from a host apparatus into a physical address of a flash memory.

If the host apparatus issues a write instruction in the memory system, a physical block having undergone an erase operation is allocated to the logical address. Data writing with priority placed thereon is performed without performing an erase operation.

### SUMMARY

In a memory system typically including a flash memory, a controller of the flash memory, and a host apparatus supplying write data, a write speed may be occasionally reduced.

For example, if data is already written on a block of the flash memory as a write destination, the data is erased before new data is written. A write speed is lower than when the new data is written on an erased block.

International Publication No. WO2005/029311 also discloses a technique of erasing an erasable physical block on another chip during the data writing.

According to the technique, a lower address space of the logical address is allocated to a memory chip A and an upper address space of the logical address is allocated to a memory chip B.

The data writing may concentrate on one address space, leaving no erasable block in the memory chip. The data erasing is performed before the writing operation. The write speed is thus reduced (see FIG. 2).

When an apparatus as an erase target is not accessed by the host apparatus (in a standby condition), a memory controller may erase an abundant block at any timing. Such an operation makes a reduction in power consumption during the standby condition difficult.

In a system that cuts off power supplying while the host apparatus does not access thereto, reserving an erase block is difficult.

It is thus desirable to provide a memory device and memory system that allow data to be written independent of the logical address during the write operation with no reduction introduced in the write speed, and that reduce power consumption during the standby condition.

A memory device of an embodiment of the present disclosure includes a plurality of nonvolatile memories configured to be erased at updating of data, and a memory controller configured to control the nonvolatile memory. The memory controller includes an address conversion table configured to convert a logical address specified by at data writing into a physical address of the nonvolatile memory, an erased physical block managing unit configured to manage an erased physical block address, the nonvolatile memory of the erased physical block address, and an erased physical block count on each nonvolatile memory, an erasable physical block managing unit configured to manage an erasable physical block address, the nonvolatile memory of the erasable physical block address, and an erasable physical block count on each nonvolatile memory, and a memory control unit configured to control writing and erasing on the plurality of nonvolatile memories. At least one physical block on each nonvolatile memory remains unallocated to a logical address space with each physical block serving as an erase unit of the nonvolatile memory. The memory control unit writes received data on a first physical block of one nonvolatile memory managed by the erased physical block managing unit while, in parallel with the writing, erasing a second physical block of another nonvolatile memory managed by the erasable physical block managing unit.

A memory system of another embodiment of the present disclosure includes a plurality of nonvolatile memories configured to be erased at updating of data, a memory controller configured to control the nonvolatile memory, and a host apparatus configured to instruct the memory controller to at least write data. The memory controller includes an address conversion table configured to convert a logical address specified by at data writing into a physical address of the nonvolatile memory, an erased physical block managing unit configured to manage an erased physical block address, the nonvolatile memory of the erased physical block address, and an erased physical block count on each nonvolatile memory, an erasable physical block managing unit configured to manage an erasable physical block address, the nonvolatile memory of the erasable physical block address, and an erasable physical block count on each nonvolatile memory, and a memory control unit configured to control writing and erasing on the plurality of nonvolatile memories. At least one physical block on each nonvolatile memory remains unallocated to a logical address space with each physical block serving as an erase unit of the nonvolatile memory. When data is received from the host apparatus, the memory control unit writes received data on a first physical block of one nonvolatile memory managed by the erased physical block managing unit while, in parallel with the writing, erasing a second physical block of another nonvolatile memory managed by the erasable physical block managing unit.

Additional features and advantages are described herein, and will be apparent from the following Detailed Description and the figures.

### BRIEF DESCRIPTION OF THE FIGURES

FIG. 1 illustrates a write unit and an erase unit according to which a write operation and an erase operation are respectively performed on a flash memory;

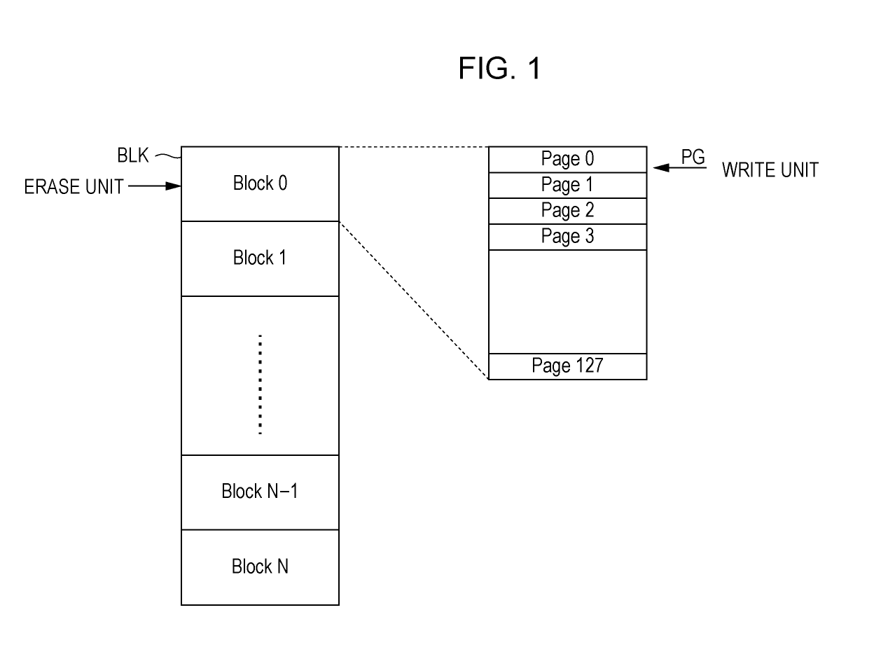

FIG. 2 illustrates a reduction in a write speed that may be caused in related art;

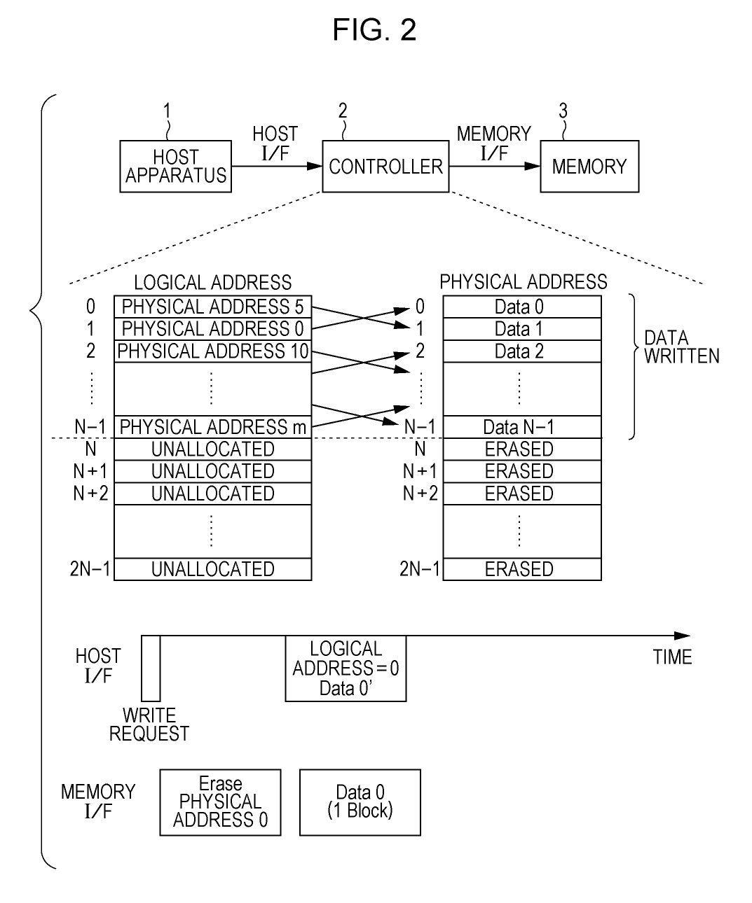

FIG. 3 illustrates a configuration of a memory system of a first embodiment;

FIG. 4 illustrates a logical-physical conversion table of the first embodiment;

FIG. 5 illustrates a boundary of a logical address;

FIG. 6 is a flowchart of a logical-physical conversion process of a logical-physical conversion control unit of the first embodiment, in which a logical address is converted into a physical address;

FIGS. 7A and 7B illustrate examples of an erased physical block list managed by an erased physical block managing unit and an erasable physical block list managed by an erasable physical block managing unit according to the first embodiment;

FIG. 8 is a flowchart illustrating a generation process of an erasable physical block address performed by the erasable physical block managing unit according to the first embodiment;

FIG. 9 is a flowchart illustrating a generation process of an erased physical block address performed by the erased physical block managing unit according to the first embodiment;

FIG. 10 illustrates a first example of the erased physical block list obtained through a method that selects a block having a smaller erase count by counting the number of erases;

FIG. 11 illustrates a second example of the erased physical block list obtained through a method that selects a block having a smaller erase count by counting the number of erases;

FIG. 12 is a flowchart illustrating a control process of a memory control unit of the first embodiment;

FIG. 13 illustrates the control process of the memory control unit in which no physical block is allocated to a logical address;

FIG. 14 illustrates the control process of the memory control unit in which a write logical address is at a logical address boundary, and a write size is equal to a physical block size;

FIG. 15 illustrates the control process of the memory control unit in which a physical address is already set to a logical address, and a physical address A responsive to a received logical address and a physical address B of a data write destination have been received;

FIG. 16 illustrates the control process of the memory control unit in which the sum of the write logical address and a write request size exceeds the boundary of the physical block;

FIG. 17 is a flowchart illustrating a specific read control process of the memory control unit of the first embodiment;

FIG. 18 is a flowchart illustrating a generation process of the erasable physical block address performed by the erasable physical block managing unit of a second embodiment;

FIG. 19 is a flowchart illustrating a generation process of the erased physical block address performed by the erased physical block managing unit of the second embodiment;

FIG. 20 illustrates a configuration of a memory system of a third embodiment;

FIG. 21 is a flowchart illustrating a generation process of the erasable physical block address performed by the erasable physical block managing unit of a third embodiment;

FIG. 22 is a flowchart illustrating a generation process of the erased physical block address performed by the erased physical block managing unit of the third embodiment;

FIG. 23 illustrates a configuration of a memory system of a fourth embodiment;

FIG. 24 illustrates a configuration of a memory system of a fifth embodiment;

FIG. 25 illustrates a configuration of a memory system of a sixth embodiment;

FIG. 26 is a flowchart illustrating an erase process of a plurality of physical blocks according to the sixth embodiment;

FIG. 27 illustrates an example of a logical-physical conversion table according to the sixth embodiment;

FIG. 28 illustrates a configuration of a memory system of a seventh embodiment;

FIG. 29 illustrates a configuration of a memory system of an eighth embodiment;

FIG. 30 is a first chart illustrating the memory system of a ninth embodiment;

FIG. 31 is a second chart illustrating the memory system of the ninth embodiment; and

FIG. 32 illustrates a feature of the memory system of the ninth embodiment.

### DETAILED DESCRIPTION

The embodiments of the present disclosure are described below with reference to the drawings.

### First Embodiment

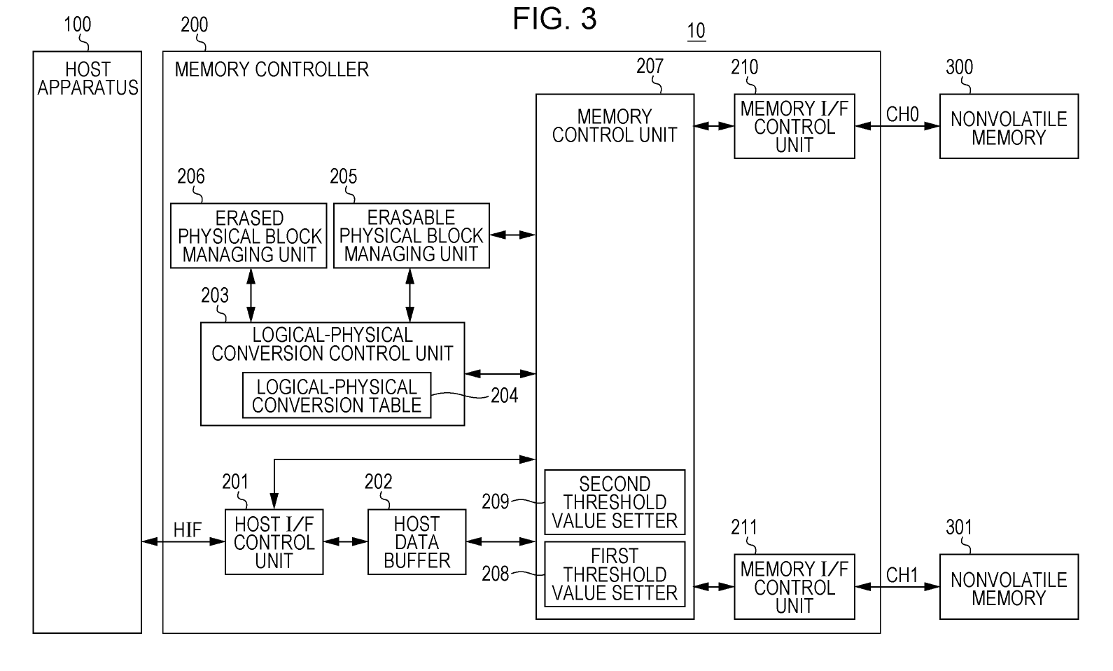

FIG. 3 illustrates a configuration of a memory system 10 of a first embodiment of the present disclosure.

The memory system 10 includes host apparatus 100, memory controller 200, and nonvolatile memories 300 and 301.

The host apparatus 100 transmits to the memory controller 200 data to be written on the nonvolatile memories 300 and 301 and an address of the data (hereinafter referred to as a logical address (LA)).

The memory controller 200 converts the logical address received from the host apparatus 100 into an address in the nonvolatile memories 300 and 301, and writes the data received from the host apparatus 100 on the nonvolatile memories 300 and 301.

The nonvolatile memories 300 and 301 write the data at the address specified by the memory controller 200.

The memory controller 200 is described in detail below.

The memory controller 200 includes host interface (I/F) control unit 201, host data buffer 202, logical-physical (logical address to physical address) conversion control unit 203, and logical-physical conversion table 204.

The memory controller 200 further includes erasable physical block managing unit 205, erased physical block managing unit 206, memory control unit 207, first threshold value setter 208, second threshold value setter 209, memory interface control unit 210, and memory interface control unit 211.

The host interface control unit 201 controls interfacing with the host apparatus 100.

The host interface control unit 201 receives from the host apparatus 100 a write command and/or a read command including a write address, a write request size, and a read request size, and notifies the memory control unit 207 of the logical address LA of the command and the size of the logical address LA.

If the command is a write request, the host interface control unit 201 transfers to the host data buffer 202 the received write data. If the command is a read request, the host interface control unit 201 outputs the data of the host data buffer 202 to the hoist interface HIF.

The host data buffer 202 temporarily retains the write data received from the host apparatus 100 and the data read from the memory control unit 207.

The logical-physical conversion control unit 203 has the logical-physical conversion (address conversion) table 204.

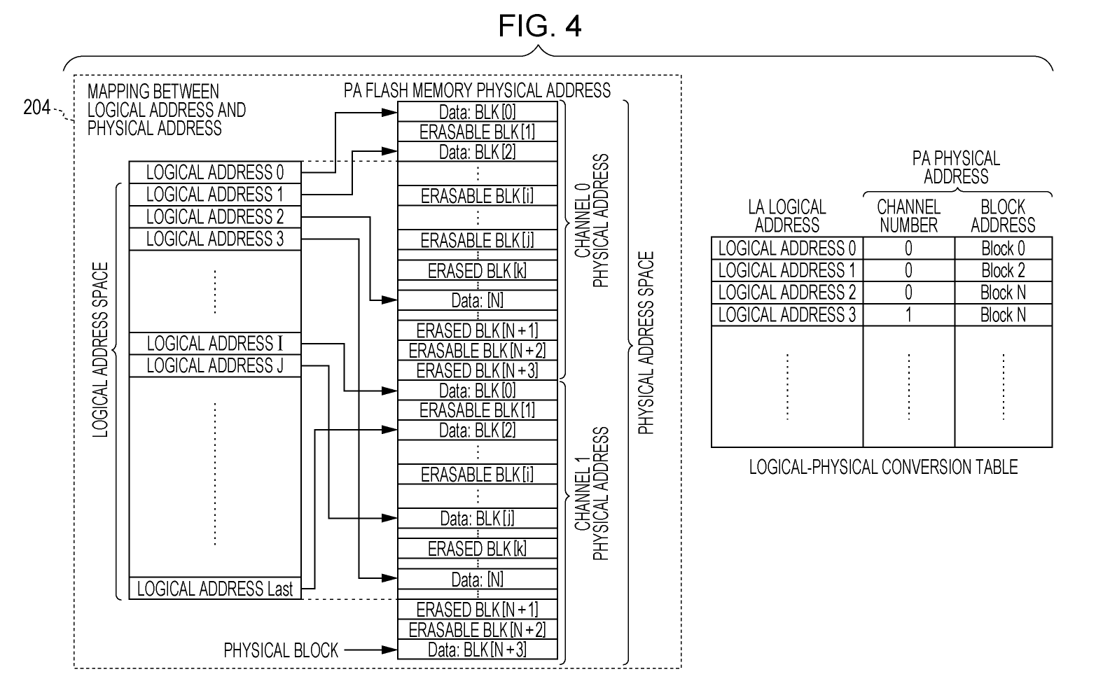

FIG. 4 illustrates an example of the logical-physical conversion table 204.

The logical-physical conversion table 204 lists a logical address LA and a physical address PA of the nonvolatile memories 300 and 301 into which the logical address LA is converted.

The logical-physical conversion control unit 203 converts the logical address LA received from the memory control unit 207 into the physical address PA of the nonvolatile memories 300 and 301 using the logical-physical conversion table 204. If the logical address LA is unallocated to the physical address PA, or if the logical address LA has been allocated to the physical address PA, the logical-physical conversion control unit 203 notifies the memory control unit 207 of the physical address PA and the physical address PA as a data write destination.

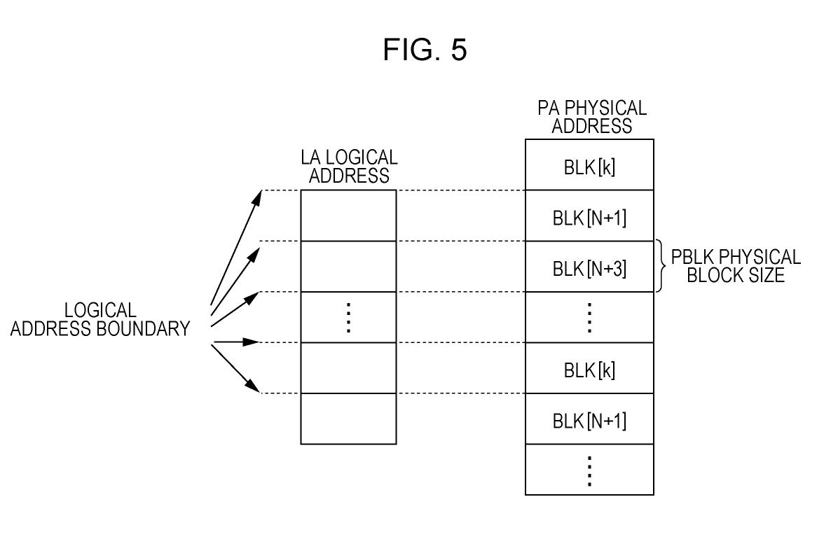

FIG. 5 illustrates a logical address boundary.

The logical address LA is allocated to the physical address PA by physical block size serving as an erase unit. As illustrated in FIG. 5, a delimitation between the logical addresses LA, each having the physical block (PBLK) size, is referred to as a logical address boundary (see FIG. 5).

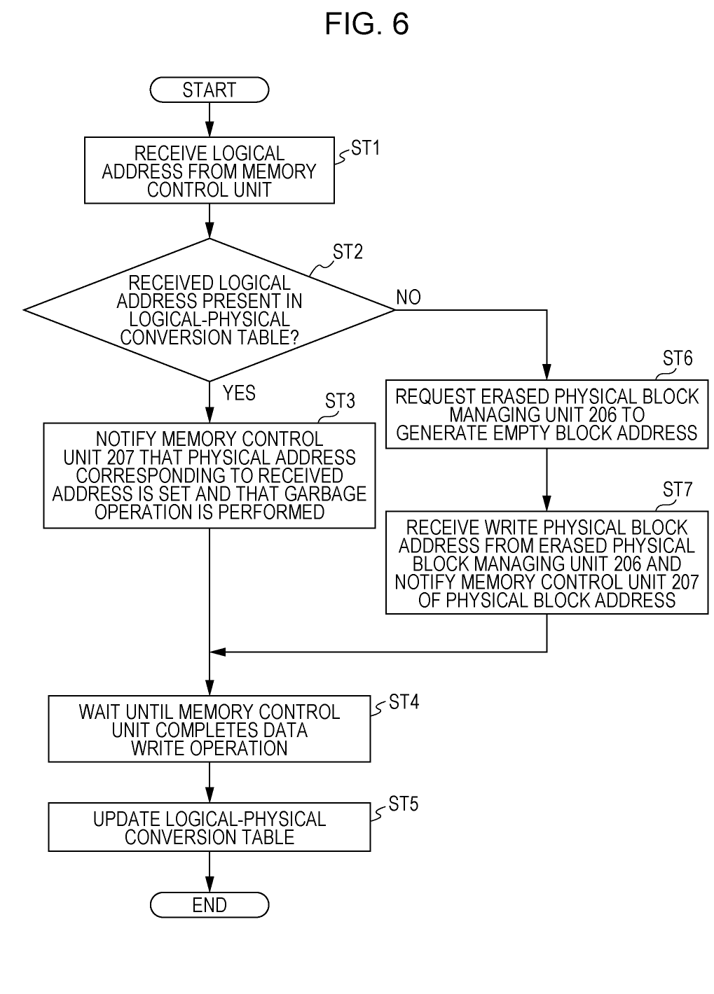

FIG. 6 is a flowchart illustrating a generation process of the logical-physical conversion control unit 203 of the first embodiment that generates a physical address from a logical address.

The logical-physical conversion control unit 203 receives the logical address LA from the memory control unit 207 (ST1), and determines whether the physical address PA corresponding to the logical address LA is present in the logical-physical conversion table 204 (ST2).

If the physical address PA corresponding to the logical address LA is present, the logical-physical conversion control unit 203 performs an operation in step ST3.

If the physical address PA corresponding to the logical address LA is present in step ST3, the logical-physical conversion control unit 203 notifies the memory control unit 207 of the physical address PA corresponding to the received logical address LA and the physical address PA as a data write destination.

The logical-physical conversion control unit 203 waits on standby until a data write operation has been completed on the memory control unit 207. Subsequent to the data write operation, the logical-physical conversion control unit 203 updates the logical-physical conversion table 204, thereby listing a relationship between the logical address LA and a new physical address PA (ST4 and ST5).

If the physical address PA corresponding to the received logical address LA is not present in step ST2, the logical-physical conversion control unit 203 requests the erased physical block managing unit 206 to generate an empty block address (ST6).

The logical-physical conversion control unit 203 receives information of an empty block address and a channel of the empty block address from the erased physical block managing unit 206, notifies the memory control unit 207 of the received information (ST7), and then proceeds to step ST4.

In step ST4, as described above, the logical-physical conversion control unit 203 waits on standby until the data write operation has been completed on the memory control unit 207. In step ST5, the relationship between the new logical address and physical address is added to the logical-physical conversion table 204.

The erasable physical block managing unit 205 manages the erasable physical block address, the channel of the erasable physical block address, and an erasable physical block count in each channel.

The erased physical block managing unit 206 manages the erased physical block address, the channel of the erased physical block address, and an erased physical block count in each channel.

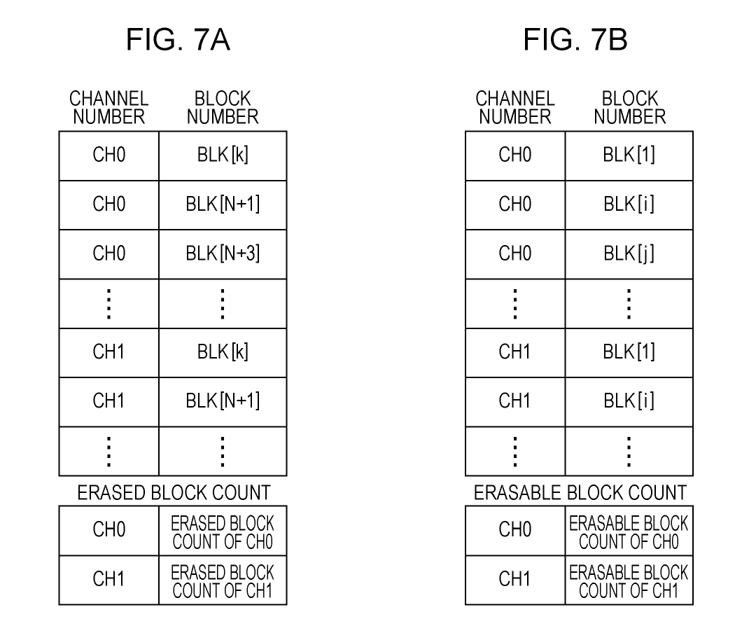

FIGS. 7A and 7B respectively illustrate examples of the erased physical block list managed by the erased physical block managing unit 206 and the erasable physical block list managed by the erasable physical block managing unit 205 according to the first embodiment.

FIG. 7A illustrates a list EDBL of the erased block EDBLK, and FIG. 7B illustrates a list EBBL of the erasable block EBBLK.

In each of the erased block list EDBL and the erasable block list EBBL, a channel number CHx (X=0, 1 here) is mapped to a block number BLK[y].

Described below is the generation process of the erasable physical block address performed by the erasable physical block managing unit 205 of the first embodiment.

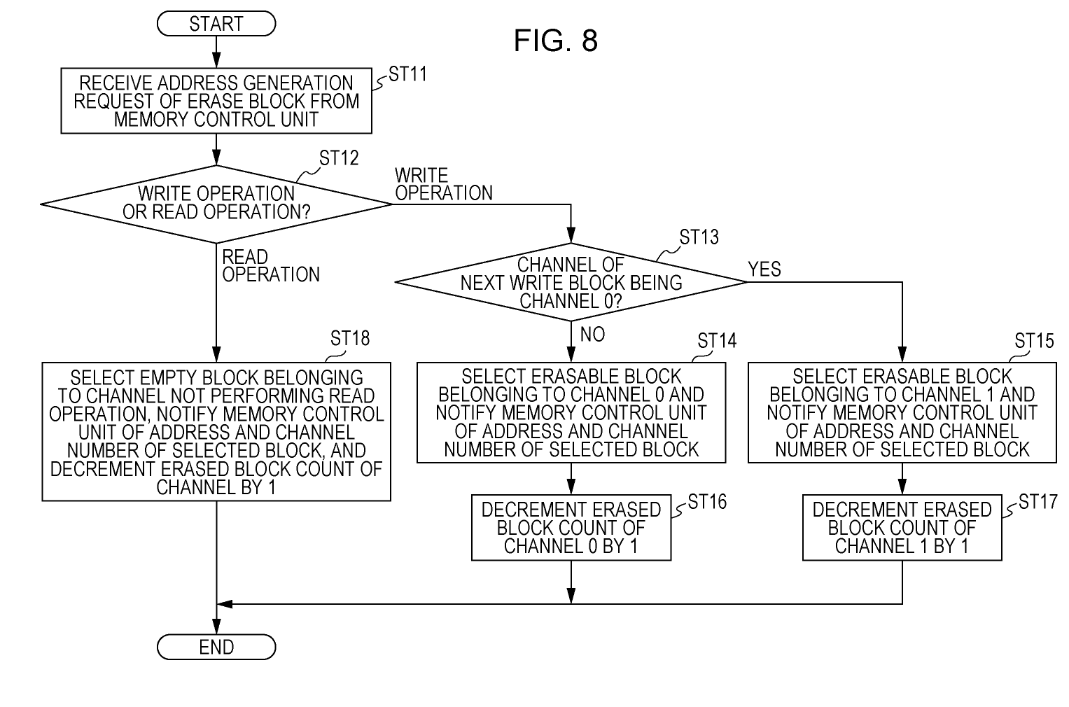

FIG. 8 is a flowchart illustrating the generation process of the erasable physical block address performed by the erasable physical block managing unit 205 of the first embodiment.

As illustrated in FIG. 7B, the erasable physical block managing unit 205 manages information of the erasable block EBBLK, and the channel of the erasable block EBBLK, and an erasable block count in each channel.

The erasable physical block managing unit 205 receives a generation request of an erase block from the memory control unit 207 (ST11).

In order to perform a write operation in response to a write command (ST12), the erasable physical block managing unit 205 performs a process described below.

The erasable physical block managing unit 205 receives from the erased physical block managing unit 206 information of a channel that is to undergo a next write operation.

The erasable physical block managing unit 205 selects an erasable block from the blocks belonging to a channel different from the received channel, and outputs information of the physical block and the channel to the memory control unit 207 (ST13, ST14, and ST15). The erasable physical block managing unit 205 decrements the erasable block count of the channel by 1 (ST16 and ST17).

As illustrated in FIG. 8, the erasable physical block managing unit 205 determines in step ST13 whether the received channel is a channel CH0. If the received channel is not the channel CH0, the erasable physical block managing unit 205 selects an erasable block belonging to the channel CH0 in step ST14. If the erasable physical block managing unit 205 determines in step ST13 that the received channel is the channel CH0, the erasable physical block managing unit 205 selects an erasable block belonging to a channel CH1 in step ST15.

In order to perform the read operation in response to the read command (ST12), the erasable physical block managing unit 205 performs a process described below.

The erasable physical block managing unit 205 selects as an erasable block a physical block belonging to a channel not used as a read channel, and outputs to the memory control unit 207 information of the physical block and the channel (ST18).

Described below is the generation process of the erased physical block address performed by the erased physical block managing unit 206 of the first embodiment.

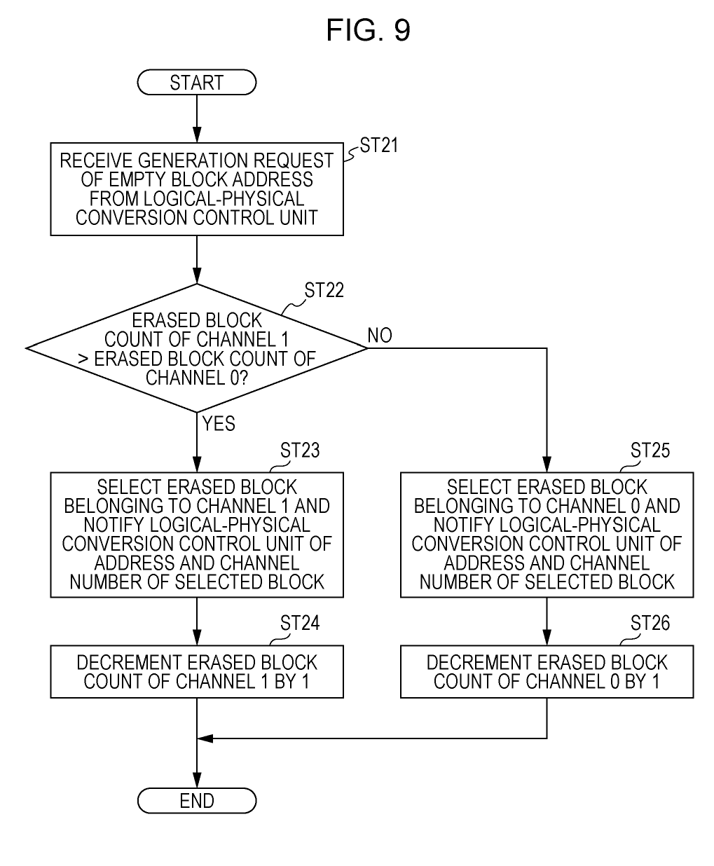

FIG. 9 is a flowchart illustrating the generation process of the erased physical block address performed by the erased physical block managing unit 206 of the first embodiment.

As illustrated in FIG. 7A, the erased physical block managing unit 206 manages information of an erased block EDBLK, and the channel of the block, and an erased block count in each channel.

The erased physical block managing unit 206 receives a generation request of an erased block address from the logical-physical conversion control unit 203 (ST21).

The erased physical block managing unit 206 determines which of a plurality of channels (two channels CH0 and CH1) has a larger erased block count (ST22).

If the channel 1 is the channel having a larger erased block count, the erased physical block managing unit 206 performs a process described below. The erased physical block managing unit 206 selects as a next write block an erased block belonging to the channel 1, and then outputs the address of the block and the channel number CH1 to the logical-physical conversion control unit 203 (ST23). The erased physical block managing unit 206 decrements the erased block count of the channel CH1 by 1 (ST24).

If the channel CH0 is the channel having a larger erased block count, the erased physical block managing unit 206 performs a process described below. The erased physical block managing unit 206 selects as a next write block an erased block belonging to the channel CH0, and outputs the address of the block and the channel number CH0 to the logical-physical conversion control unit 203 (ST25). The erased physical block managing unit 206 decrements the erased block count of the channel CH0 by 1 (ST26).

Two methods are available to select a next write block from among the erased blocks belonging to a given channel.

In one method, a block is selected as the next write block in the order of registration of the erased blocks. In the other method, a block having a smaller erase count is selected as the next write block by counting the number of erases.

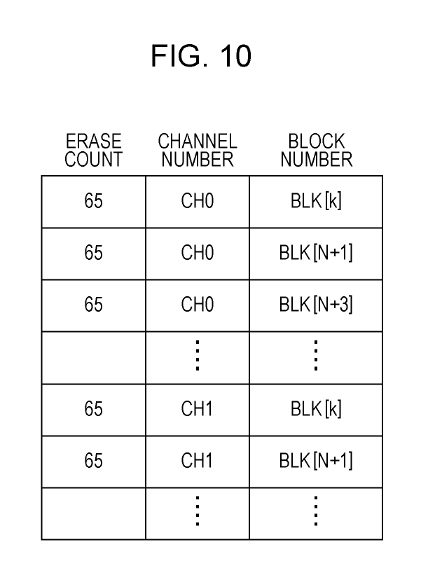

FIG. 10 illustrates a first example of an erased block list in the method in which the block having the smaller erase count is selected by counting the number of erases.

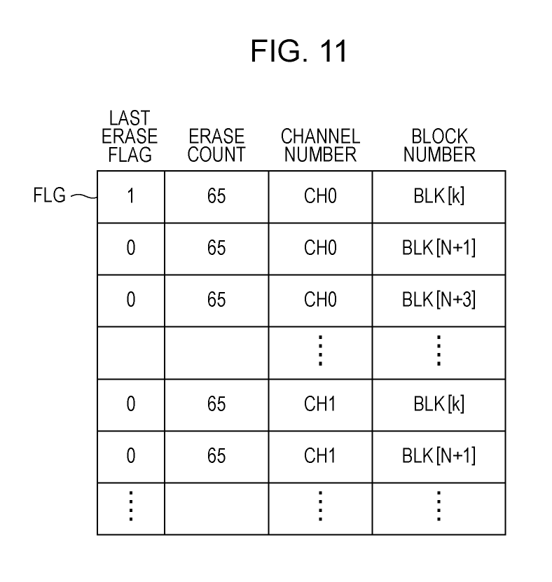

FIG. 11 illustrates a second example of an erased block list in the method in which the block having the smaller erase count is selected by counting the number of erases.

In the method of FIG. 10, the erased physical block managing unit 206 counts the number of erases, and selects a block having a smaller erase count.

The method of FIG. 11, based on the method of FIG. 10, takes into consideration a flag FLG determining a block having undergone last erasing. A block having the smallest erase count but not having the flag FLG set is selected.

A basic operation of the memory control unit 207 is described below.

The basic control process of the memory control unit 207 is described below.

If writing or reading exceeds the logical address boundary with respect to the logical address LA, the write size and the read size received from the host apparatus 100, the memory control unit 207 outputs the logical address LA to the logical-physical conversion control unit 203 on a per logical address boundary basis. The memory control unit 207 receives the physical address PA corresponding to the logical address LA, and then writes and reads data of the write size and the read size, respectively.

A write control process of the memory control unit 207 is specifically described below.

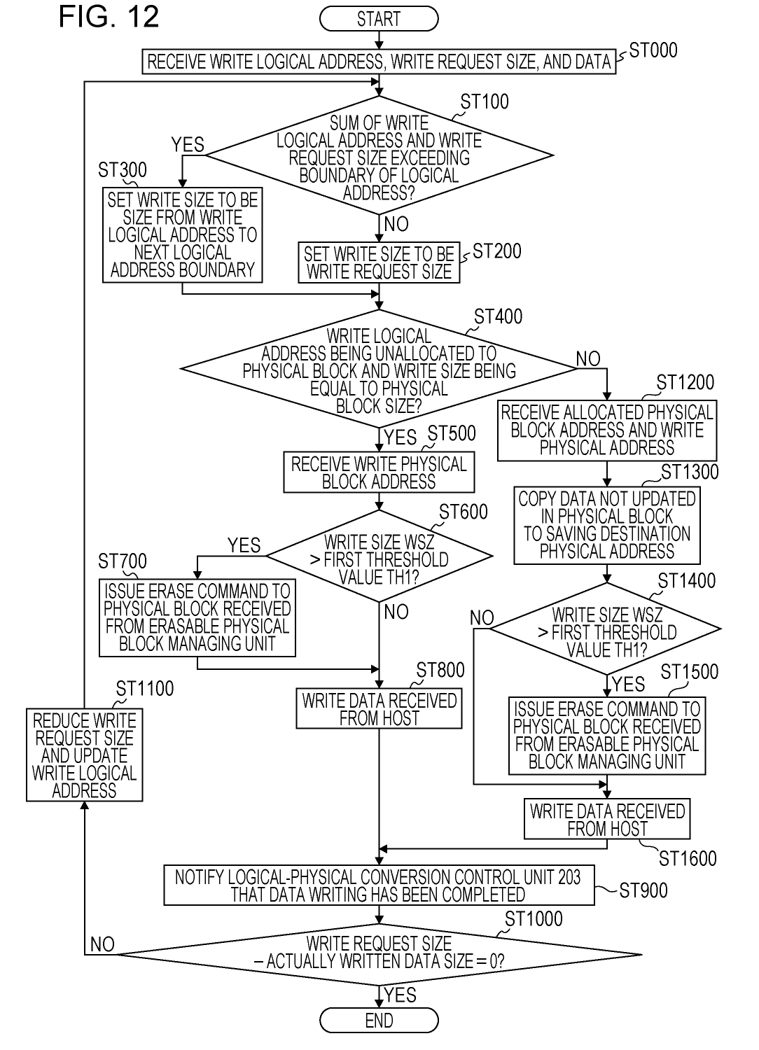

FIG. 12 is a flowchart illustrating the control process of the memory control unit 207 of the first embodiment.

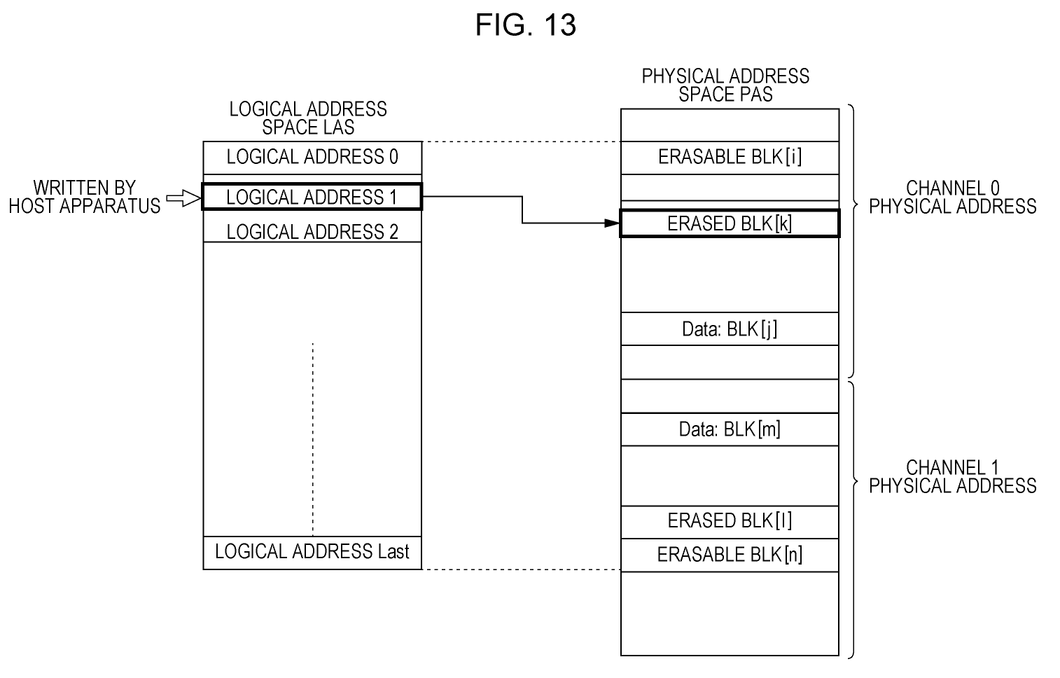

FIG. 13 illustrates the control process of the memory control unit 207 in which no physical block is allocated to a logical address.

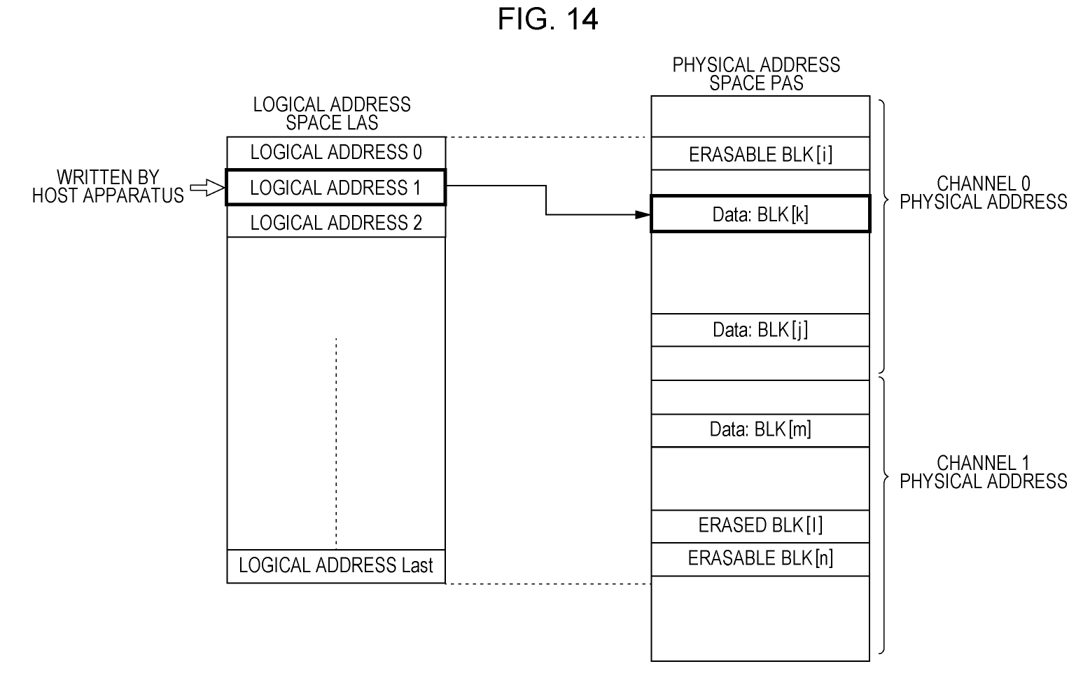

FIG. 14 illustrates the control process of the memory control unit 207 in which a write logical address is at a logical address boundary, and a write size is equal to a physical block size.

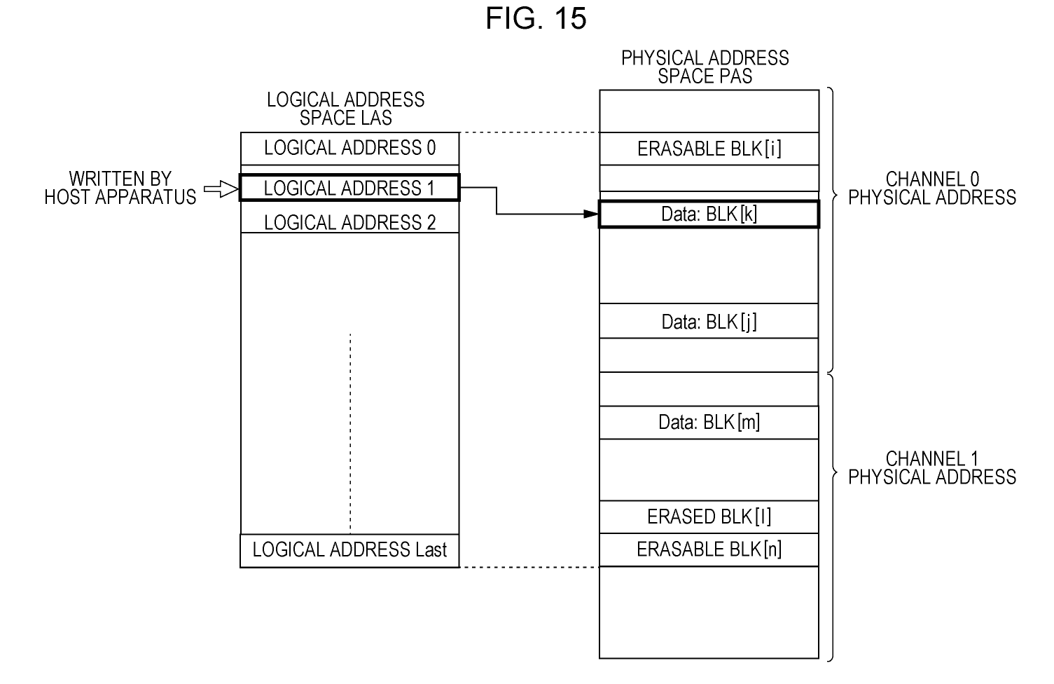

FIG. 15 illustrates the control process of the memory control unit 207 in which a physical address is already set to a logical address, and a physical address A responsive to a received logical address and a physical address B of a data write destination have been received.

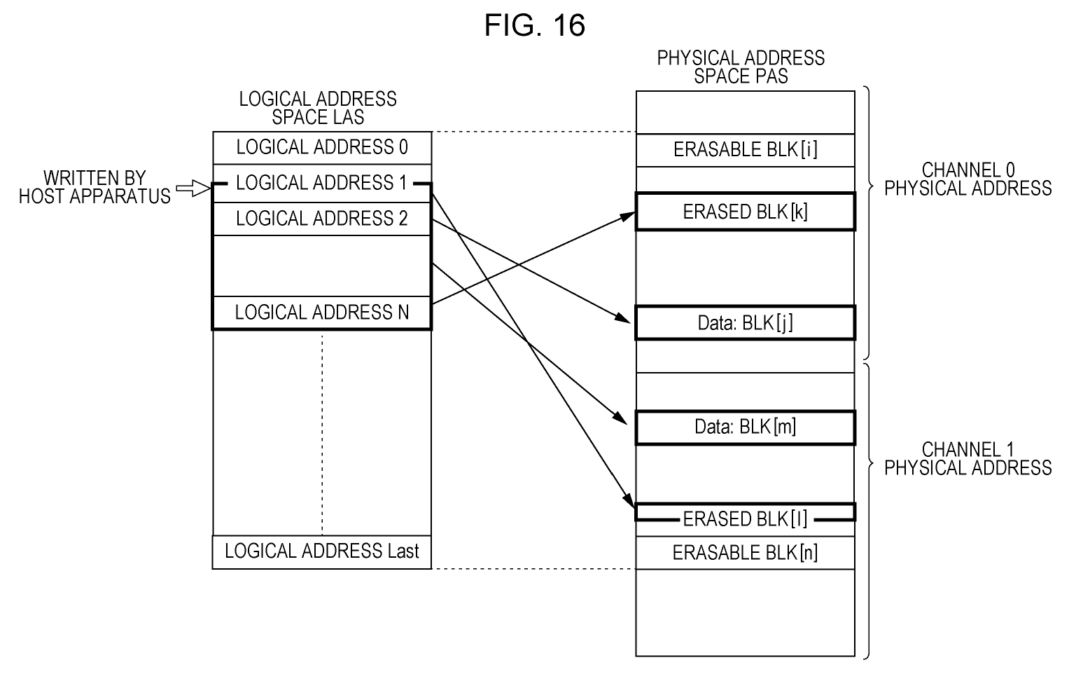

FIG. 16 illustrates the control process of the memory control unit 207 in which the sum of the write logical address and a write request size exceeds the boundary of the physical block.

In FIGS. 13 through 16, a logical address space LAS is mapped to a physical address space PAS.

In response to a data write request from the host apparatus 100 (ST000), the memory control unit 207 determines whether the sum of a write logical address and a write request size exceeds the logical address boundary (ST100).

If the memory control unit 207 determines in step ST 100 that the sum of the write logical address and the write request size does not exceed the logical address boundary, the memory control unit 207 sets the write size to be the write request size (ST200), and outputs the logical address LA to the logical-physical conversion control unit 203.

If the memory control unit 207 determines in step ST100 that the sum of the write logical address and the write request size exceeds the logical address boundary, the memory control unit 207 performs an operation in step ST300 to be discussed later. The memory control unit 207 then outputs the logical address LA to the logical-physical conversion control unit 203.

The memory control unit 207 receives from the logical-physical conversion control unit 203 a determination result as to whether the write logical address is unallocated (unset) to the physical address.

If it is determined in step ST400 as illustrated in FIG. 13 that no physical address is allocated to the logical address, the memory control unit 207 receives a write physical block address C from the logical-physical conversion control unit 203 (ST500).

The memory control unit 207 then determines whether a write data size WSZ is larger than a first threshold value TH1 preset in the first threshold value setter 208 (ST600).

If the write data size WSZ is larger than the first threshold value TH1 of the first threshold value setter 208, the memory control unit 207 issues an erase command to a physical block of a channel of which the erasable physical block managing unit 205 notifies the memory control unit 207. The memory control unit 207 thus erases at least one physical block (ST700). In parallel with issuing the erase command, the memory control unit 207 writes the write data from the host apparatus 100 onto the physical block address of the other channel (ST800).

If the write data size WSZ is not larger than (or smaller than) the first threshold value TH1 of the first threshold value setter 208, the memory control unit 207 erases no physical block, and writes the write data from the host apparatus 100 onto the physical block address (ST800).

The memory control unit 207 then notifies the logical-physical conversion control unit 203 that the data writing has been completed (ST900).

The memory control unit 207 determines whether the write request size is equal to an actually written data size (ST1000).

Since the write request size is equal to the actually written data size here, the process ends.

If the memory control unit 207 determines in step ST400 that the write logical address is at the logical address boundary and that the write size is equal to the physical block size as illustrated in FIG. 14, the memory control unit 207 outputs the write logical address and receives the write physical block address C converted by the logical-physical conversion control unit 203 (ST500).

The memory control unit 207 then determines whether the write data size WSZ is larger than the first threshold value TH1 preset in the first threshold value setter 208 (ST600).

If the write data size WSZ is larger than the first threshold value TH1 of the first threshold value setter 208, the memory control unit 207 issues an erase command to a physical block of a channel of which the erasable physical block managing unit 205 notifies the memory control unit 207. The memory control unit 207 thus erases at least one physical block (ST700). In parallel with issuing the erase command, the memory control unit 207 writes the write data from the host apparatus 100 onto the physical block address of the other channel (ST800).

If the write data size WSZ is not larger than (or smaller than) the first threshold value TH1 of the first threshold value setter 208, the memory control unit 207 erases no physical block, and writes the write data from the host apparatus 100 onto the physical block address (ST800).

The memory control unit 207 then notifies the logical-physical conversion control unit 203 that the data writing has been completed (ST900).

The memory control unit 207 determines whether the write request size is equal to an actually written data size (ST1000).

Since the write request size is equal to the actually written data size here, the process ends here.

If the memory control unit 207 determines in step ST400 that the physical address is allocated to the logical address and that the write size is not equal to the physical block size, the logical-physical conversion control unit 203 receives a physical address A corresponding to the received logical address and a physical address B as a data write destination as illustrated in FIG. 15 (ST1200).

The memory control unit 207 copies data not updated out of the data in the physical block of the physical address A to a physical block of the physical address B (ST1300). The copying operation is hereinafter referred to as a garbage operation.

The memory control unit 207 determines whether the write data size WSZ is larger than the first threshold value TH1 preset in the first threshold value setter 208 (ST1400).

If the write data size WSZ is larger than the first threshold value TH1 of the first threshold value setter 208, the memory control unit 207 issues an erase command to a physical block of a channel of which the erasable physical block managing unit 205 notifies the memory control unit 207. The memory control unit 207 thus erases at least one physical block (ST1500). In parallel with issuing the erase command, the memory control unit 207 writes the write data from the host apparatus 100 onto the physical block address of the other channel (ST1600).

If the write data size WSZ is not larger than the first threshold value TH1 of the first threshold value setter 208, the memory control unit 207 erases no physical block, and writes the write data from the host apparatus 100 onto the physical block address (ST1600).

The memory control unit 207 then notifies the logical-physical conversion control unit 203 that the data writing has been completed (ST900). Since the write request size is equal to the actually written data size, the process ends here (ST1000).

If the sum of the write logical address and the write request size exceeds the logical address boundary in step ST100 as illustrated in FIG. 16, the memory control unit 207 sets the write size to be a size from the write logical address to the next logical boundary (ST300).

The memory control unit 207 then performs a process starting with step ST400.

If the write request size is not equal to the actually written data size in step ST1000, the memory control unit 207 performs a process discussed below.

The memory control unit 207 subtracts the actually written data size from the write request size, and sets the resulting difference to be a new write request size. The memory control unit 207 then adds the actually written data size to the write logical address, and sets the resulting sum to be a new write logical address. The memory control unit 207 repeats the process starting with step ST100 until the write request size becomes zero.

A read control process of the memory control unit 207 is described specifically below.

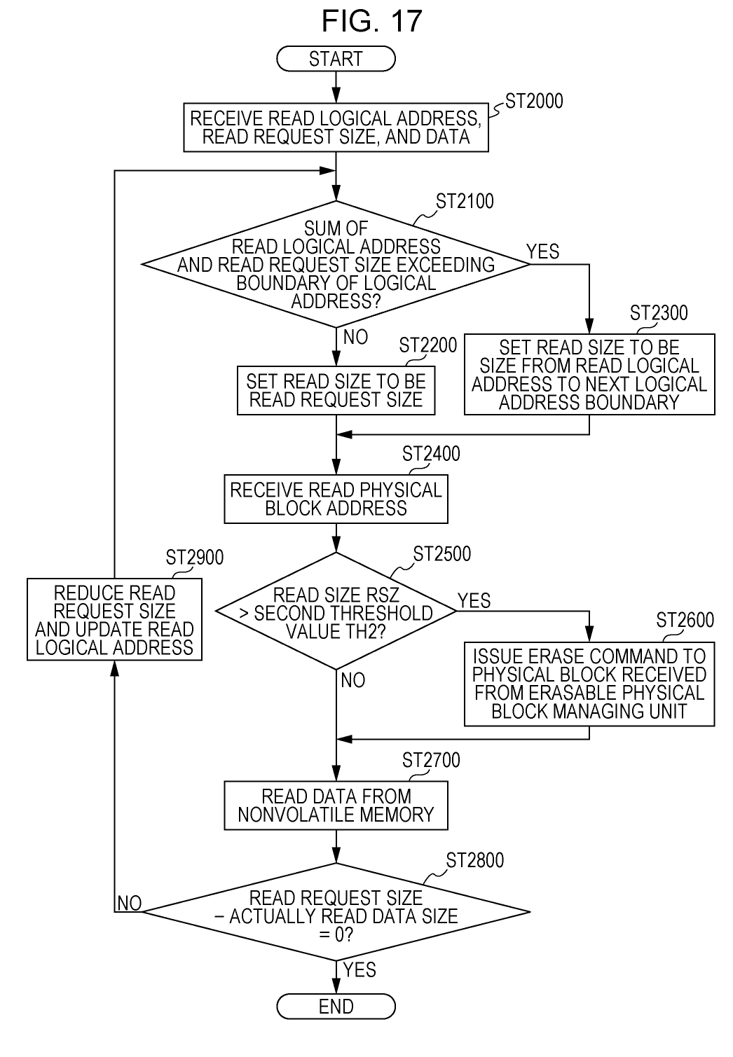

FIG. 17 is a flowchart illustrating the specific read control process of the memory control unit 207 of the first embodiment.

In response to a data read request from the host apparatus 100, the memory control unit 207 performs a process described below.

The memory control unit 207 receives a read logical address, a read request size, and data from the host apparatus 100 (ST2000).

The memory control unit 207 determines whether the sum of the read logical address and the read request size exceeds the boundary of the physical block (ST2100).

If the sum of the read logical address and the read request size does not exceed the boundary of the physical block in step ST2100, the memory control unit 207 sets the read request size to be the read size (ST2200).

If the sum of the read logical address and the read request size exceeds the boundary of the physical block in step ST2100, the memory control unit 207 sets the read size to be a size from the leading read logical address to the next logical address boundary (ST2300).

The memory control unit 207 outputs the logical address to the logical-physical conversion control unit 203 and receives the physical address as a read destination from the logical-physical conversion control unit 203 (ST2400).

The memory control unit 207 determines whether a read data size RSZ is larger than a second threshold value TH2 preset in the second threshold value setter 209 (ST2500).

If the read data size RSZ is larger than the second threshold value TH2 of the second threshold value setter 209, the memory control unit 207 issues an erase command to a physical block of which the erasable physical block managing unit 205 notifies the memory control unit 207, and erases at least one physical block (ST2600).

Subsequent to the erase operation, the memory control unit 207 reads data via the memory interface control unit 210 into the channel and the physical address corresponding to the read logical address received from the logical-physical conversion control unit 203. The memory control unit 207 then stores the read data onto the host data buffer 202 (ST2700).

If the read data size RSZ is not larger (or is smaller) than the second threshold value TH2 of the second threshold value setter 209, the memory control unit 207 erases no physical block, and reads data from the nonvolatile memory, and outputs the read data to the host data buffer 202 (ST2700).

The memory control unit 207 determines whether the read request size is equal to the actually read data size (ST2800).

If the read request size is not equal to the actually read data size in step ST2800, the memory control unit 207 subtracts the actually read data size from the read request size, and sets the resulting difference to be a new read request size.

The memory control unit 207 then adds the actually read data size to the read logical address, and sets the resulting sum to be a new read logical address. The memory control unit 207 repeats the process (ST2800, and ST2900) until the read request size becomes equal to the actually read data size.

According to the first embodiment, a write request of a logical address aligned with the logical address boundary may have a size equal to an integer multiple of the physical block size. In response to such a write request, data writing is performed in a manner free from a reduction in the write speed at the data writing regardless of the logical address.

### Second Embodiment

The basic structure of a memory system of a second embodiment is identical to that of the first embodiment.

The difference between the first embodiment and the second embodiment lies in the generation process of the erasable physical block address and the generation process of the erased physical block address.

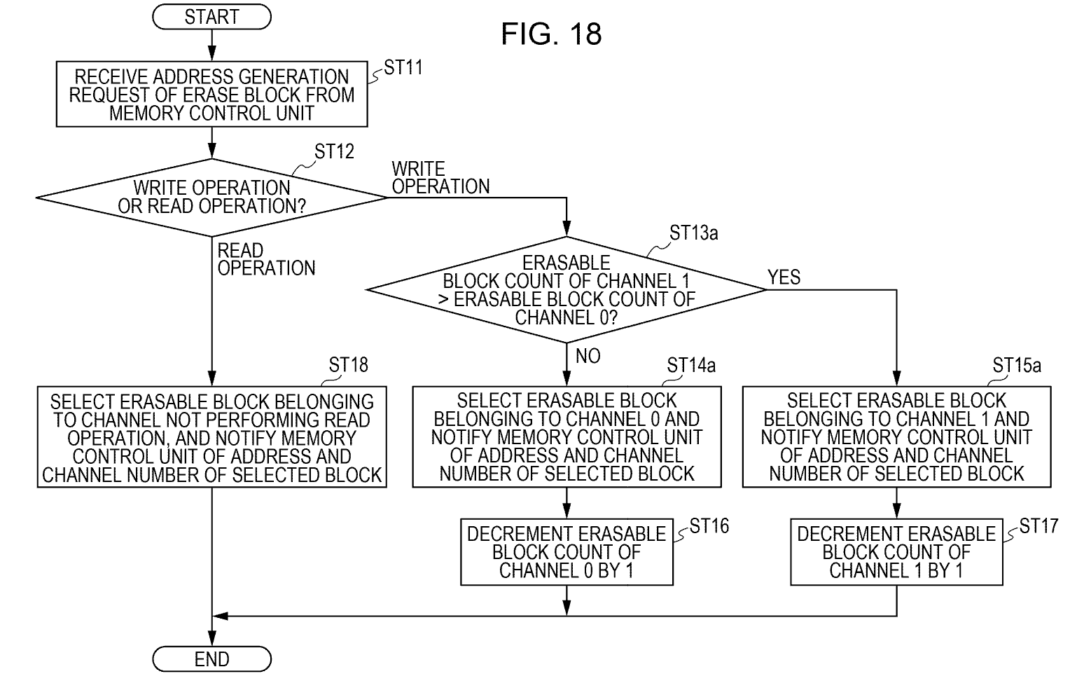

FIG. 18 is a flowchart illustrating the generation process of the erasable physical block address performed by the erasable physical block managing unit 205 of the second embodiment.

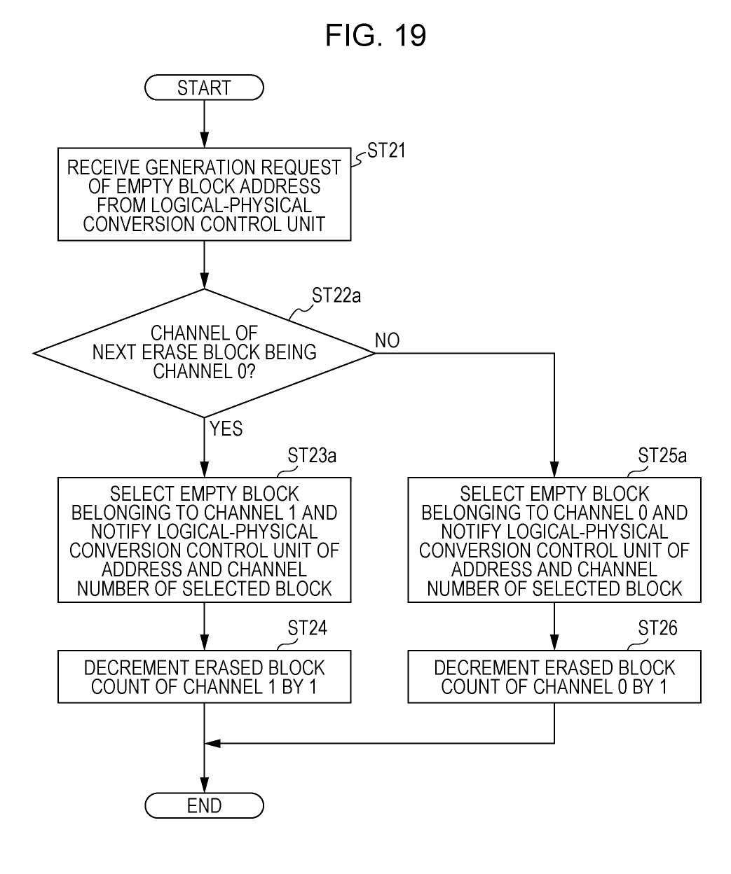

FIG. 19 is a flowchart illustrating the generation process of the erased physical block address performed by the erased physical block managing unit 206 of the second embodiment.

Referring to FIGS. 18 and 19, operations identical those in FIGS. 8 and 9 are designated with the same step numbers to help understand the processes.

The generation process of the erasable physical block address performed by the erasable physical block managing unit 205 of the second embodiment is described with reference to FIG. 18.

As illustrated in FIG. 7B, the erasable physical block managing unit 205 manages the information of the erasable block EBBLK, and the channel of the block, and the erasable block count in each channel.

The erasable physical block managing unit 205 receives the generation request of the erase block from the memory control unit 207 (ST11).

In order to perform the write operation in response to the write command (ST12), the erasable physical block managing unit 205 performs a process described below.

The erasable physical block managing unit 205 selects an erasable block from the blocks belonging to a channel having a larger erasable block count, and outputs information of the physical block and the channel to the memory control unit 207 (ST13a, ST14a, and ST15a). The erasable physical block managing unit 205 decrements the erasable block count of the channel by 1 (ST16 and ST17).

As illustrated in FIG. 18, the erasable physical block managing unit 205 determines in step ST13a whether the erasable block count of the channel CH1 is larger than the erasable block count of the channel CH0. If the erasable block count of the channel CH0 is larger in step ST13a, the memory control unit 207 selects an erasable block belonging to the channel CH0 in step ST14a. If the erasable block count of the channel CH1 is larger in ST13a, the memory control unit 207 selects an erasable block belonging to the channel CH1 in step ST15a.

In order to perform the read operation in response to the read command (ST12), the erasable physical block managing unit 205 performs a process described below.

The erasable physical block managing unit 205 selects as an erasable block a physical block belonging to a channel not used as a read channel, and outputs to the memory control unit 207 information of the physical block and the channel (ST18).

The generation process of the erased physical block address performed by the erased physical block managing unit 206 of the second embodiment is described with reference to FIG. 19.

As illustrated in FIG. 7A, the erased physical block managing unit 206 manages information of an erased block EDBLK, and the channel of the block, and an erased block count in each channel.

The erased physical block managing unit 206 receives a generation request of an erase block address from the logical-physical conversion control unit 203 (ST21).

The erased physical block managing unit 206 determines the channel of a next erase block is a predetermined channel (the channel CH0, for example) (ST22a).

If the channel of the next erase block is the channel CH0, the erased physical block managing unit 206 performs a process described below.

The erased physical block managing unit 206 selects as a next write block an empty block (erased block) belonging to the channel CH1 different from the channel CH0, and outputs the address of the block and the channel number CH1 to the logical-physical conversion control unit 203 (ST23a). The erased physical block managing unit 206 decrements the erased block count of the channel CH1 by 1 (ST24).

If the channel of the next erase block is not the channel CH0, the erased physical block managing unit 206 performs a process described below.

The erased physical block managing unit 206 selects as a next write block an empty block (erased block) belonging to the channel CH0 and outputs the address of the block and the channel number CH1 to the logical-physical conversion control unit 203 (ST25a). The erased physical block managing unit 206 then decrements the erased block count of the channel 0 by 1 (ST26).

As described above, the two methods are available to select the next write block from among the erased blocks belonging to a given channel.

In one method, a block is selected as the next write block in the order of registration of the erased blocks. In the other method, a block having a smaller erase count is selected as the next write block by counting the number of erases.

As described above, FIG. 10 illustrates the first example of the erased block list in the method in which the block having the smaller erase count is selected by counting the number of erases.

FIG. 11 illustrates the second example of the erased block list in the method in which the block having the smaller erase count is selected by counting the number of erases.

In the method of FIG. 10, the erased physical block managing unit 206 counts the number of erases, and selects a block having a smaller erase count.

The method of FIG. 11, based on the method of FIG. 10, takes into consideration a flag FLG determining a block having undergone last erasing. A block having the smallest erase count but not having the flag FLG set is selected.

### Third Embodiment

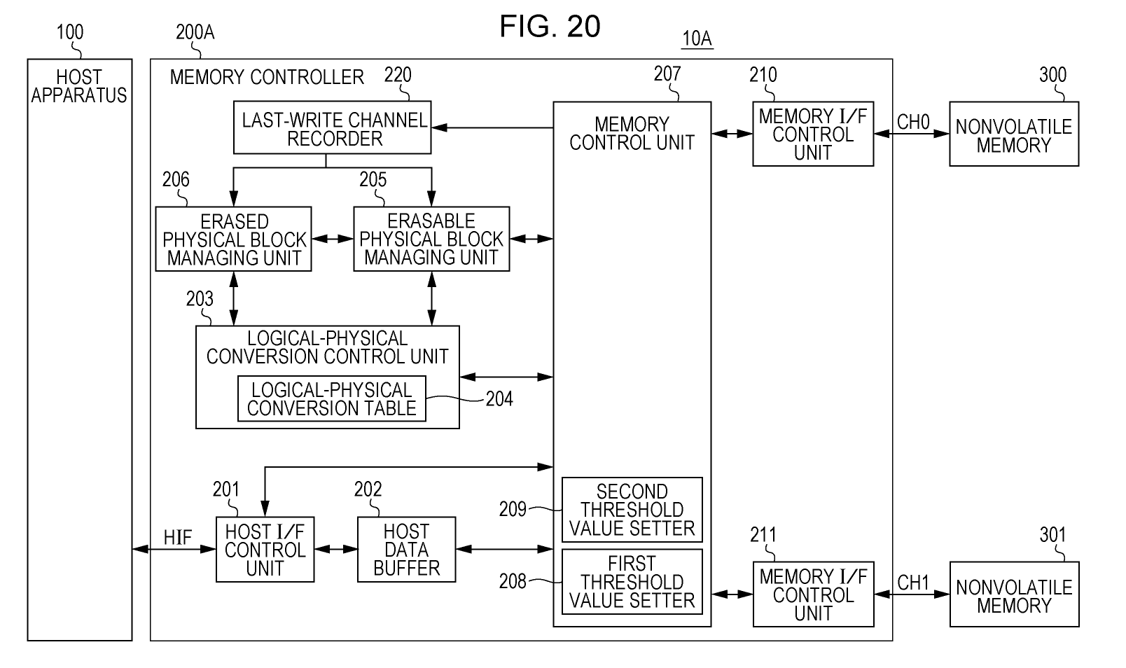

FIG. 20 illustrates a configuration of a memory system 10A of a third embodiment.

The memory system 10A of the third embodiment is different from the memory system 10 of the first embodiment in the points described below.

The memory system 10A of the third embodiment includes a last-write channel recorder 220 in the memory controller 200A.

The third embodiment is also different from the first embodiment in the generation process of the erasable physical block address and the generation process of the erased physical block address.

The memory control unit 207 in the memory system 10A outputs to the last-write channel recorder 220 a signal indicating one of the channel CH0 and the channel CH1 having undergone the write operation.

The last-write channel recorder 220 thus records which of the channels CH0 and CH1 having undergone last data writing, and supplies that information to the erasable physical block managing unit 205 and the erased physical block managing unit 206.

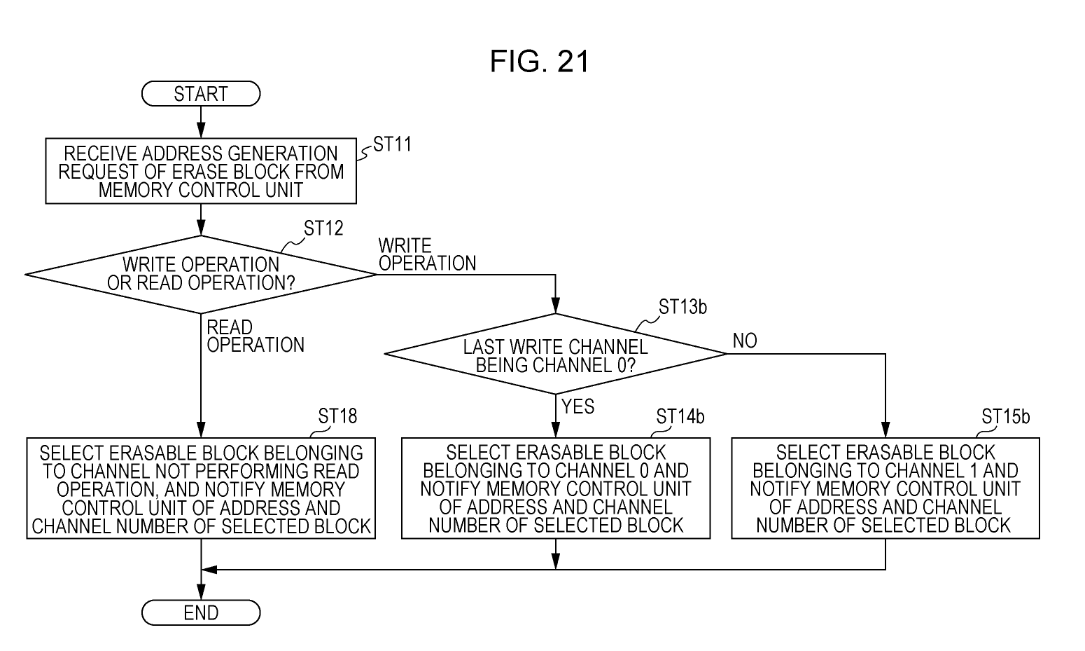

FIG. 21 is a flowchart illustrating the generation process of the erasable physical block address performed by the erasable physical block managing unit 205 of the third embodiment.

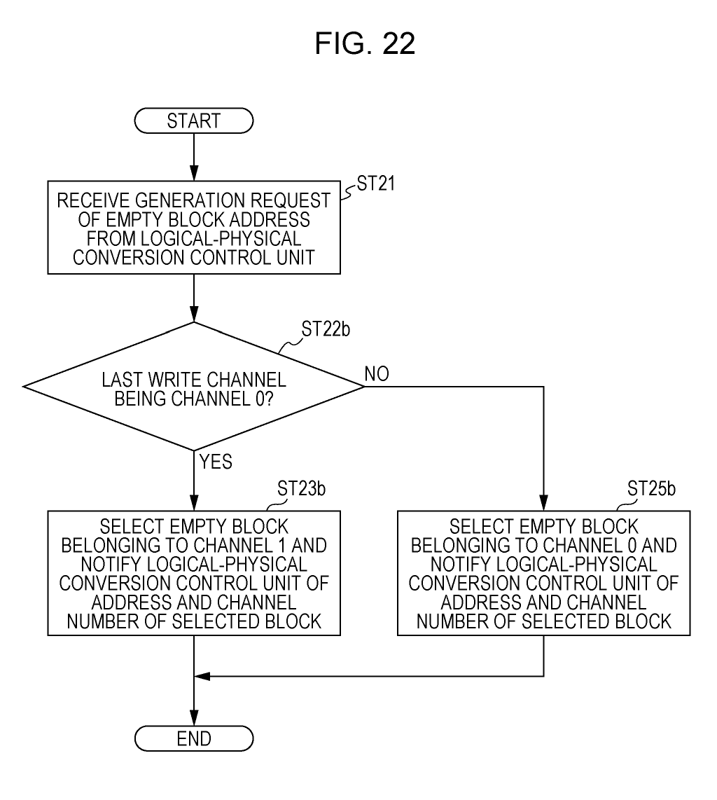

FIG. 22 is a flowchart illustrating the generation process of the erased physical block address performed by the erased physical block managing unit 206 of the third embodiment.

Referring to FIGS. 21 and 22, operations identical those in FIGS. 8 and 9 are designated with the same step numbers to help understand the processes.

The generation process of the erasable physical block address performed by the erasable physical block managing unit 205 of the third embodiment is described with reference to FIG. 21.

As illustrated in FIG. 7B, the erasable physical block managing unit 205 manages the information of the erasable block EBBLK, and the channel of the block, and the erasable block count in each channel.

The erasable physical block managing unit 205 receives the generation request of the erase block from the memory control unit 207 (ST11).

In order to perform the write operation in response to the write command (ST12), the erasable physical block managing unit 205 performs a process described below.

The erasable physical block managing unit 205 receives information of a channel having undergone last data writing from the last-write channel recorder 220.

The erasable physical block managing unit 205 selects an erasable block from the blocks belonging to the channel used last as the write channel, and outputs information of the physical block and the channel to the memory control unit 207 (ST13b, ST14b, and ST15b).

As illustrated in FIG. 21, the erasable physical block managing unit 205 determines in step ST13b whether the last write channel is the channel CH0. If the last write channel is the channel CH0 in step ST13b, the erasable physical block managing unit 205 selects an erasable block belonging to the channel CH0 in step ST14b. If the last write channel is not the channel CH0 in step ST13b, the erasable physical block managing unit 205 selects an erasable block belonging to the channel CH1 in step ST15b.

In order to perform the read operation in response to the read command (ST12), the erasable physical block managing unit 205 performs a process described below.

The erasable physical block managing unit 205 selects as an erasable block a physical block belonging to a channel not used as a read channel, and outputs to the memory control unit 207 information of the physical block and the channel (ST18).

The generation process of the erased physical block address performed by the erased physical block managing unit 206 of the third embodiment is described with reference to FIG. 22.

As illustrated in FIG. 7A, the erased physical block managing unit 206 manages information of an erased block EDBLK, and the channel of the block, and an erased block count in each channel.

The erased physical block managing unit 206 receives a generation request of an erase block address from the logical-physical conversion control unit 203 (ST21).

The erased physical block managing unit 206 determines whether the last write channel is a predetermined channel (the channel CH0, for example) (ST22b).

If the last write channel is the channel CH0, the erased physical block managing unit 206 performs a process described below.

The erased physical block managing unit 206 selects an empty block (erased block) belonging to the channel CH1 different from the channel CH0, and outputs the address of the block and the channel number CH1 to the logical-physical conversion control unit 203 (ST23b).

If the last write channel is not the channel CH0, the erased physical block managing unit 206 performs a process described below.

The erased physical block managing unit 206 selects an empty block (erased block) belonging to the channel CH0 and outputs the address of the block and the channel number CH1 to the logical-physical conversion control unit 203 (ST25b).

As described above, the two methods are available to select the next write block from among the erased blocks belonging to a given channel.

In one method, a block is selected as the next write block in the order of registration of the erased blocks. In the other method, a block having a smaller erase count is selected as the next write block by counting the number of erases.

As described above, FIG. 10 illustrates the first example of the erased block list in the method in which the block having the smaller erase count is selected by counting the number of erases.

FIG. 11 illustrates the second example of the erased block list in the method in which the block having the smaller erase count is selected by counting the number of erases.

In the method of FIG. 10, the erased physical block managing unit 206 counts the number of erases, and selects a block having a smaller erase count.

The method of FIG. 11, based on the method of FIG. 10, takes into consideration a flag FLG determining a block having undergone last erasing. A block having the smallest erase count but not having the flag FLG set is selected.

### Fourth Embodiment

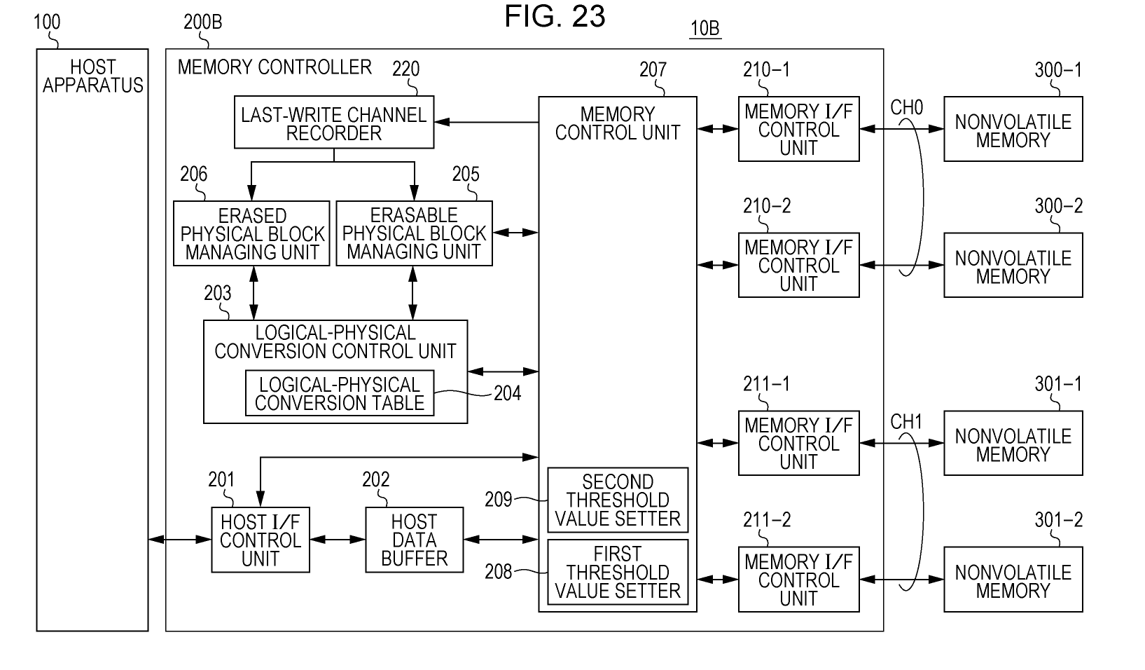

FIG. 23 illustrates a configuration of a memory system 10B of a fourth embodiment.

The memory system 10B of the fourth embodiment is different from the memory system 10A of the third embodiment in the points described below.

The memory system 10B of the fourth embodiment includes a plurality of memory interface control units. Channel information includes information identifying each of the memory interface control units.

Referring to FIG. 23, the channel CH0 includes two memory interface control units 210-1 and 210-2. The memory interface control unit 210-1 is connected to a nonvolatile memory 300-1, and the memory interface control unit 210-2 is connected to a nonvolatile memory 300-2.

Similarly, the channel CH1 includes two memory interface control units 211-1 and 211-2. The memory interface control unit 211-1 is connected to a nonvolatile memory 301-1 and the memory interface control unit 211-2 is connected to a nonvolatile memory 301-2.

This arrangement is also applicable to the first embodiment and the second embodiment, each of which is without the last-write channel recorder 220.

### Fifth Embodiment

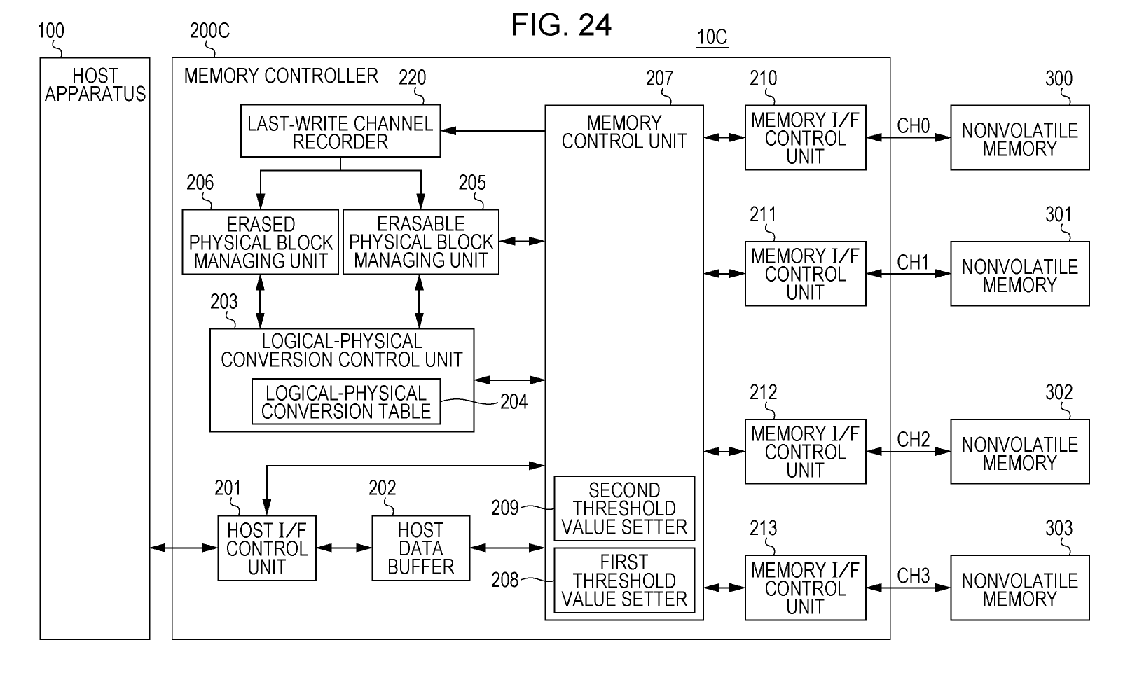

FIG. 24 illustrates a configuration of a memory system 10C of a fifth embodiment.

The memory system 10C of the fifth embodiment is different from the memory system 10A of the third embodiment in the points described below.

The memory system 10C of the fifth embodiment includes channels more than two channels.

The memory system 10C of FIG. 24 includes four channels CH0-CH3.

The channel CH0 includes a memory interface control unit 210 connected to a nonvolatile memory 300.

The channel CH1 includes a memory interface control unit 211 connected to a nonvolatile memory 301.

The channel CH2 includes a memory interface control unit 212 connected to a nonvolatile memory 302.

The channel CH3 includes a memory interface control unit 213 connected to a nonvolatile memory 303.

This arrangement is also applicable to the first embodiment and the second embodiment, each of which is without the last-write channel recorder 220.

### Sixth Embodiment

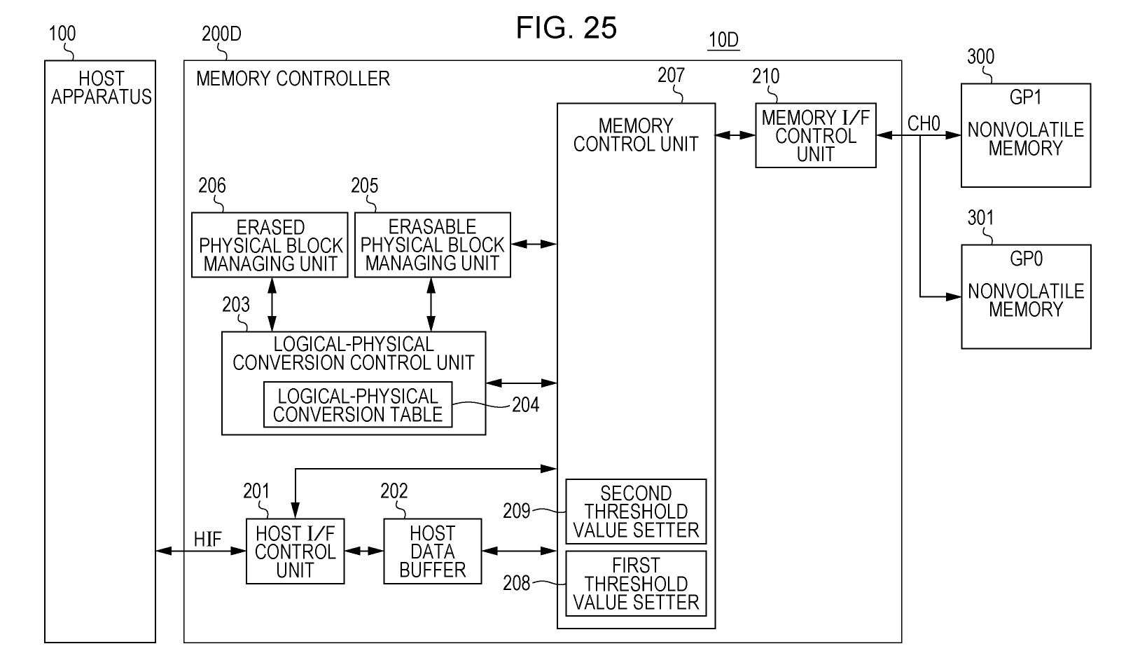

FIG. 25 illustrates a configuration of a memory system 10D of a sixth embodiment.

The memory system 10D of the sixth embodiment is different from the memory system 10 of the first embodiment in the points described below.

The memory system 10D of the sixth embodiment includes only one memory interface control unit 210.

The memory interface control unit 210 is connected to a plurality of nonvolatile memories. The plurality of nonvolatile memories are sorted into a plurality of groups (GP0, GP1, . . . ), and substitute for the channels in the first embodiment.

As illustrated in FIG. 25, the memory interface control unit 210 connects to two nonvolatile memories 300 and 301 via the channel CH0.

The nonvolatile memory 300 is sorted as the group GP0, and the nonvolatile memory 301 is sorted as the group GP1.

According to the sixth embodiment, a process of erasing a plurality of physical blocks is different from the process of the first embodiment (steps ST600-ST900 as illustrated in FIG. 12).

The process of erasing the plurality of physical blocks in the sixth embodiment is described below.

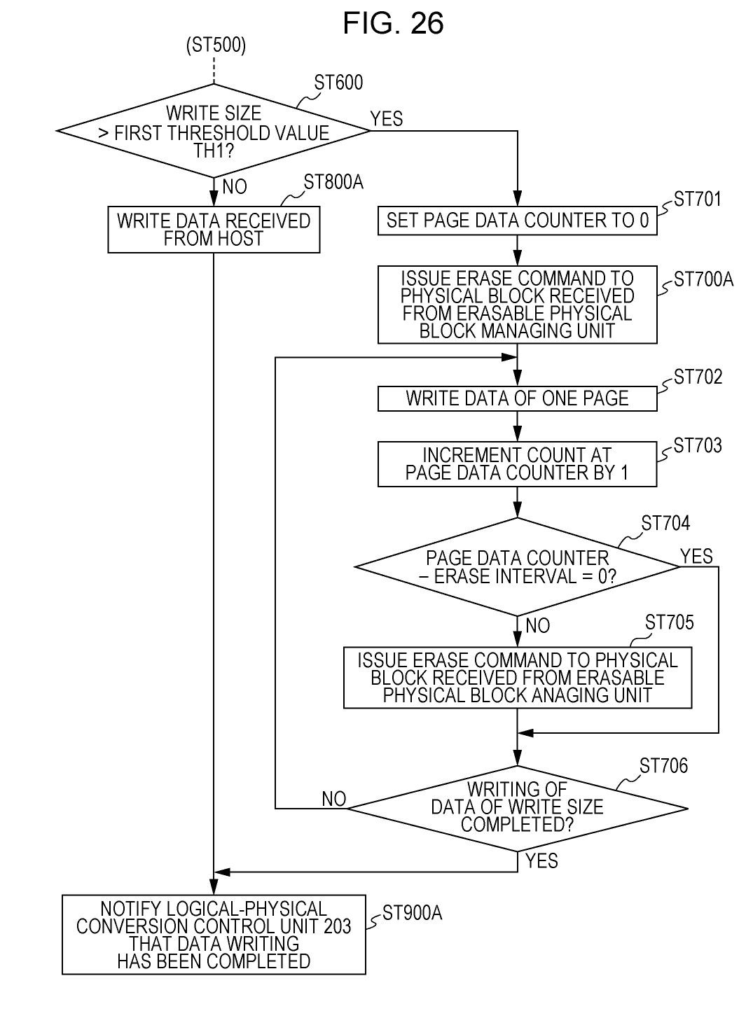

FIG. 26 is a flowchart illustrating an erase process of the plurality of physical blocks according to the sixth embodiment.

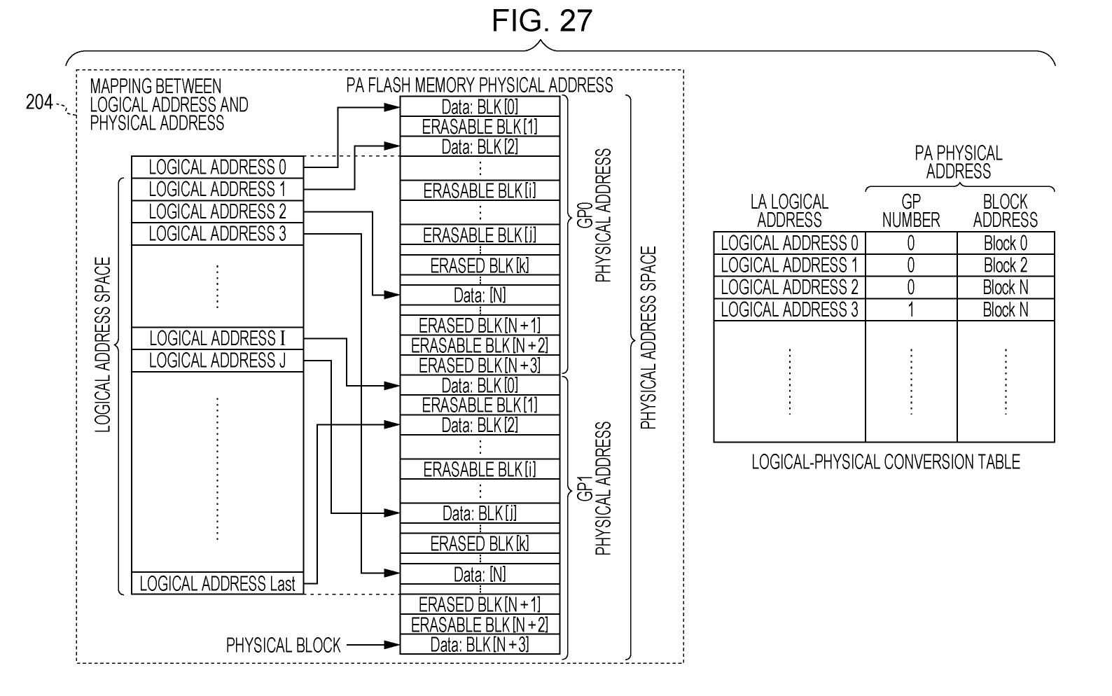

FIG. 27 illustrates an example of a logical-physical conversion table according to the sixth embodiment.

In the sixth embodiment, the memory interface control unit 210 connects to the plurality of nonvolatile memories. If the writing of data of several pages is complete in the course of the writing of the data from the host apparatus 100 (ST704), the memory control unit 207 monitors the progress of the erase operation performed on the group. Upon completing the erase operation, the memory control unit 207 issues a next erase command.

More specifically, the memory control unit 207 receives the write physical block address from the logical-physical conversion control unit 203 in step ST500 of FIG. 12.

The memory control unit 207 then determines whether the write data size WSZ is larger than the first threshold value TH1 set in the first threshold value setter 208 (ST600).

If the write data size WSZ is larger than the first threshold value TH1 of the first threshold value setter 208, the memory control unit 207 performs a process of FIG. 26.

The memory control unit 207 sets the value at the page counter to zero (ST701), issues an erase command to a physical block of a channel of which the erasable physical block managing unit 205 notifies the memory control unit 207, and erases at least one physical blocks (ST700A).

The memory control unit 207 writes one page (ST702), and increments the page counter by 1 (ST703).

If the writing of data of several pages is complete in the course of the writing of the data from the host apparatus 100 (ST704), the memory control unit 207 monitors the progress of the erase operation performed on the group. Upon completing the erase operation, the memory control unit 207 issues a next erase command (ST705 and ST706).

If the writing of the data of the write size is complete, the memory control unit 207 notifies the logical-physical conversion control unit 203 that the data writing has been completed (ST900A).

If the write data size WSZ is not larger than the first threshold value TH1 of the first threshold value setter 208, the memory control unit 207 does not perform the erase operation, and writes the write data from the host apparatus 100 onto the physical block address (ST800A).

The memory control unit 207 notifies the logical-physical conversion control unit 203 that the data writing has been completed (ST900A).

### Seventh Embodiment

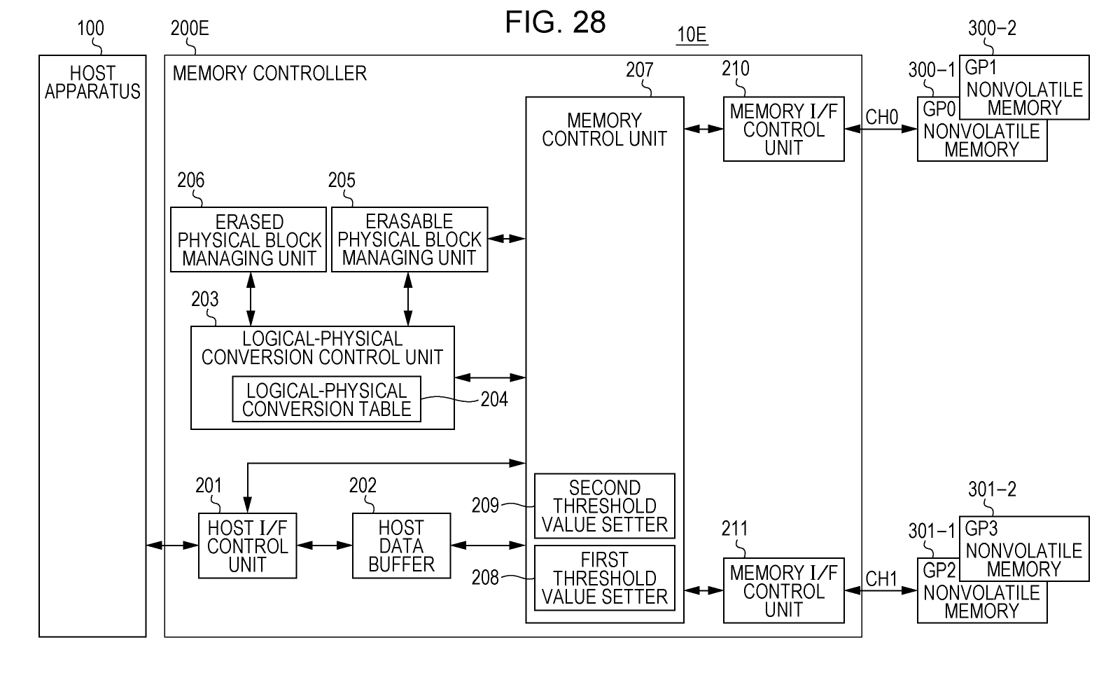

FIG. 28 illustrates a configuration of a memory system 10E of a seventh embodiment.

The memory system 10E of the seventh embodiment is different from the memory system 10 of the first embodiment in the points described below.

In the memory system 10E of the seventh embodiment, each memory interface control unit connects to a plurality of nonvolatile memories. The plurality of nonvolatile memories are sorted into a plurality of groups (GP0, GP1, . . . ). During the writing on the nonvolatile memory, the erase operation on another channel and another group is also controlled.

As illustrated in FIG. 28, the memory interface control unit 210 connects to nonvolatile memories 300-1 and 300-2 via the channel CH0.

The nonvolatile memory 300-1 is sorted as the group GP0, and the nonvolatile memory 300-2 is sorted as the group GP1.

The memory interface control unit 211 connects to nonvolatile memories 301-1 and 301-2 via the channel CH1.

The nonvolatile memory 301-1 is sorted as the group GP2, and the nonvolatile memory 301-2 is sorted as the group GP3.

### Eighth Embodiment

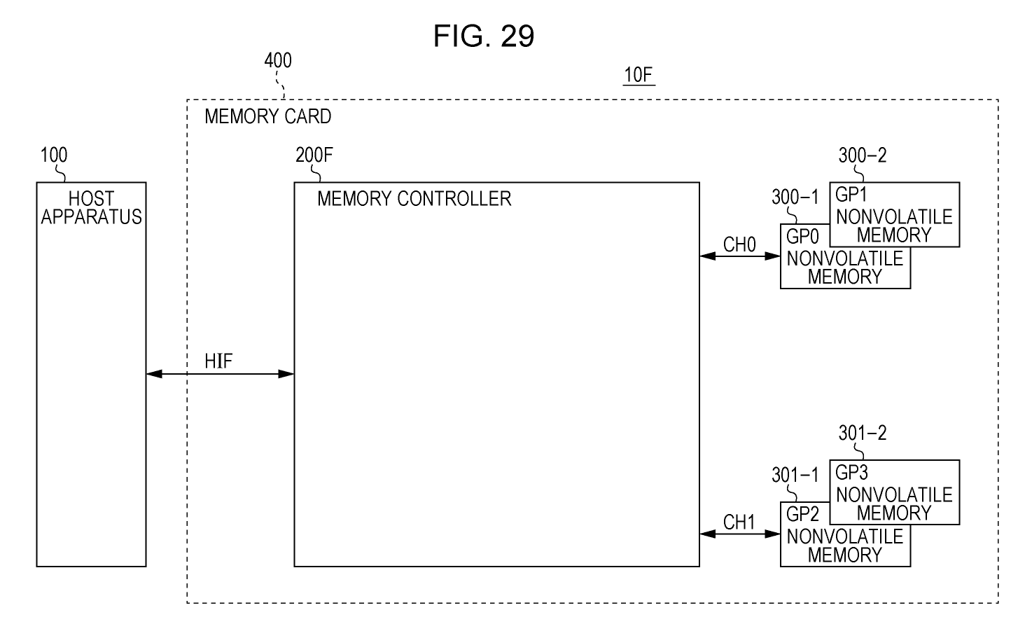

FIG. 29 illustrates a configuration of a memory system 10F of an eighth embodiment.

The memory system 10F of the eighth embodiment includes a memory card 400 including a memory controller 200F and plurality of nonvolatile memories.

As illustrated in FIG. 29, the plurality of nonvolatile memories are connected in a fashion similar to the way the plurality of nonvolatile memories are connected as illustrated in FIG. 28. The memory controller and the nonvolatile memory in each of the first through seventh embodiments may be integrated into the memory card 400.

The memory card 400 may be shifted into a low-power consumption state in response to an instruction from the host apparatus 100.

The system including the memory card 400 and the host apparatus 100 may be implemented as a memory system that is powered off by the intervention of the host apparatus.

### Ninth Embodiment

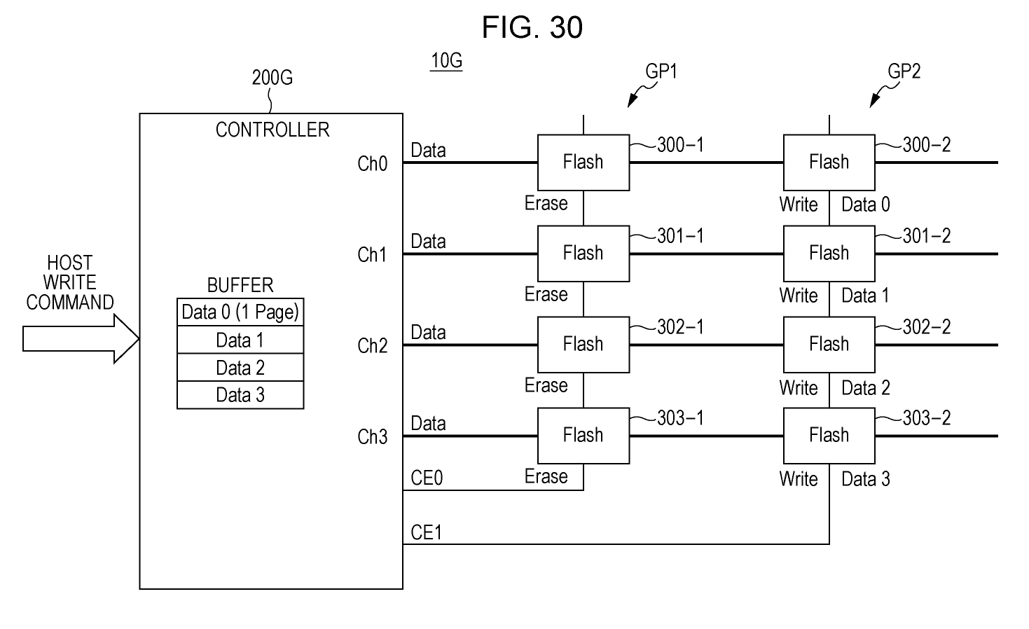

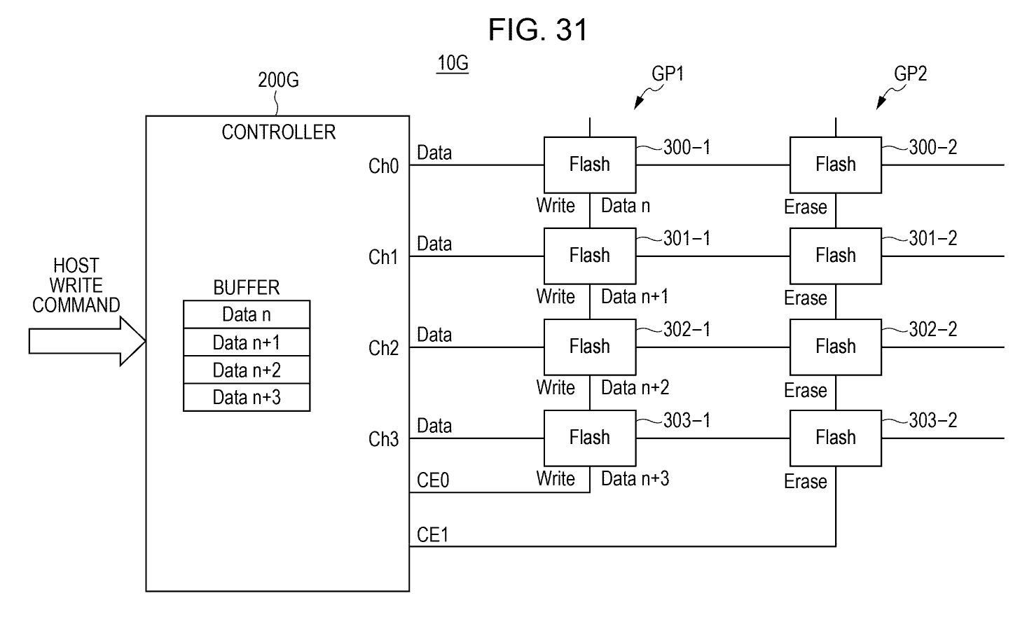

FIGS. 30 and 31 illustrate a memory system 10G of a ninth embodiment.

The memory system 10G of the ninth embodiment controls the write operation and the erase operation in response to a chip enable signal CE of the nonvolatile memory.

The memory system 10G includes four channels CH0-CH3. The channels CH0-CH3 respectively connect to two nonvolatile memories (flash memories), i.e., 300-1 and 300-2, 301-1 and 301-2, 302-1 and 302-2, and 303-1 and 303-2.

The nonvolatile memories 300-1, 301-1, 302-1, and 303-1 in the first group GP1 are controlled by a chip enable signal CE0.

The nonvolatile memories 300-2, 301-2, 302-2, and 303-2 in the second group GP2 are controlled by a chip enable signal CE1.

As illustrated in FIG. 30, a write command is transferred from the host apparatus to a memory controller 200G.

The memory controller 200G transmits an erase command to the nonvolatile memories 300-1 through 303-1 if one of the nonvolatile memories in the group GP1 controlled by the chip enable signal CE0 has a block to be erased.

When the nonvolatile memories 300-1 through 303-1 are busy with the erase operation, data is transferred to the nonvolatile memories 300-2 through 303-2 in the second group GP2 controlled by the chip enable signal CE1 for data writing.

If the write data is larger than a block size as illustrated in FIG. 31 or if the next write command is transmitted as illustrated in FIG. 31, a process described below is performed.

The memory controller 200G transmits an erase command to the nonvolatile memories 300-2 through 303-2 if one of the nonvolatile memories in the group GP2 controlled by the chip enable signal CE1 has a block to be erased.

When the nonvolatile memories 301-2 through 303-2 are busy with the erase operation, data is transferred to the nonvolatile memories 300-1 through 303-1 in the second group GP1 controlled by the chip enable signal CE0 for data writing.

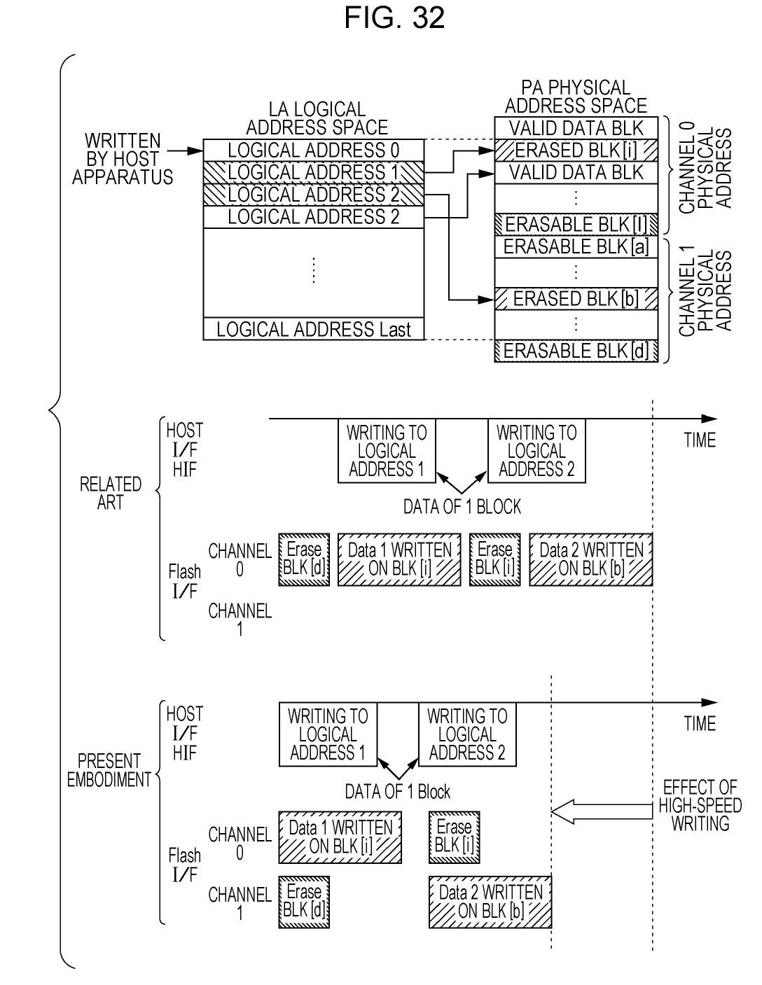

According to the embodiments, the write request of the logical address aligned with the logical address boundary may have a size equal to an integer multiple of the physical block size as illustrated in FIG. 32. In response to such a write request, data writing is performed at the data writing in a manner free from a reduction in the write speed regardless of the logical address.

The erase operation is performed in synchronization with the host apparatus, but not performed at a timing unpredicted by the host apparatus. Power reduction effect during the standby period becomes effective.

The host apparatus may stop supplying power to the memory card or the like at any timing.

The method described above may be implemented as a program including the above-described steps. The program is thus executed by a computer such as a CPU.

The program may be supplied in a recorded state on recording media including a semiconductor memory, a magnetic disc, an optical disc, and a floppy (registered trademark) disc. The recording medium is loaded onto a computer and the computer accesses and executes the program on the recording medium.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A memory device comprising:
a plurality of nonvolatile memories configured to be erased at updating of data; and
a memory controller configured to control the nonvolatile memory,
wherein the memory controller includes
an address conversion table configured to convert a logical address specified by at data writing into a physical address of the nonvolatile memory;
an erased physical block managing unit configured to manage an erased physical block address, the nonvolatile memory of the erased physical block address, and an erased physical block count on each nonvolatile memory;
an erasable physical block managing unit configured to manage an erasable physical block address, the nonvolatile memory of the erasable physical block address, and an erasable physical block count on each nonvolatile memory; and
a memory control unit configured to control writing and erasing on the plurality of nonvolatile memories;
wherein at least one physical block on each nonvolatile memory remains unallocated to a logical address space with each physical block serving as an erase unit of the nonvolatile memory; and
wherein the memory control unit writes received data on a first physical block of one nonvolatile memory managed by the erased physical block managing unit while, in parallel with the writing, erasing a second physical block of another nonvolatile memory managed by the erasable physical block managing unit.

2. The memory device according to claim 1, wherein the memory controller comprises a plurality of channels, the channel serving as an interface to be connected to the nonvolatile memory;
wherein the channel includes at least one physical block serving as the erase unit of the nonvolatile memory, as a physical block unallocated to the logical address space;
wherein the erased physical block managing unit manages the erased physical block address, the channel of the erased physical block address, and the erased physical block count in each channel;
wherein the erasable physical block managing unit manages the erasable physical block address, the channel of the erasable physical block address, and the erasable physical block count in each channel;
wherein when data are received, the erased physical block managing unit allocates a physical block belonging to a channel having a larger erased physical block count, as the first physical block corresponding to the logical address;
wherein in response to the received data, the erasable physical block managing unit selects a physical block belonging to a channel not serving as a write destination, as the second physical block to be erased; and
wherein in response to the received data, the memory control unit erases the second physical block while writing the received data on the first physical block in parallel.

3. The memory device according to claim 1, wherein the memory controller comprises a plurality of channels, the channel serving as an interface to be connected to the nonvolatile memory,
wherein the channel includes at least one physical block serving as the erase unit of the nonvolatile memory, as a physical block unallocated to the logical address space;
wherein the erased physical block managing unit manages the erased physical block address, the channel of the erased physical block address, and the erased physical block count in each channel;
wherein the erasable physical block managing unit manages the erasable physical block address, the channel of the erasable physical block address, and the erasable physical block count in each channel;
wherein when data are received, the erased physical block managing unit allocates a physical block belonging to a channel not serving as an erase target, as the first physical block corresponding to the logical address;
wherein in response to the received data, the erasable physical block managing unit selects a physical block belonging to a channel having a larger erasable physical block count, as the second physical block to be erased; and
wherein in response to the received data, the memory control unit erases the second physical block while writing the received data on the first physical block in parallel.

4. The memory device according to claim 1, wherein the memory controller comprises:
a plurality of channels, the channel serving as an interface to be connected to the nonvolatile memory, and including at least one physical block serving as the erase unit of the nonvolatile memory, as a physical block unallocated in the logical address space; and
a last-write channel recorder configured to record information of a channel having undergone last writing;
wherein the erased physical block managing unit manages the erased physical block address, and the channel of the erased physical block address;
wherein the erasable physical block managing unit manages the erasable physical block address, and the channel of the erasable physical block address;
wherein when data are received, the last-write channel recorder checks a channel having undergone preceding writing;
wherein in response to the received data, the erased physical block managing unit allocates a physical block belonging to a channel having undergone no preceding writing, as the first physical block corresponding to the logical address;
wherein in response to the received data, the erasable physical block managing unit selects a physical block belonging to a channel having undergone the preceding writing, as the second physical block to be erased; and
wherein in response to the received data, the memory control unit erases the second physical block while writing the received data on the first physical block in parallel, and subsequent to the data writing, the memory control unit notifies the last-write channel recorder of information relating to the channel having undergone the data writing.

5. The memory device according to claim 1, wherein the memory controller, in response to a write request exceeding the boundary of a size of the physical block, reselects a physical block to be erased and a physical block as a write destination below or beyond the boundary.

6. The memory device according to claim 5, wherein if the size of write data to the physical block is larger than a first threshold value, the memory controller writes the data in one channel while erasing a block in another channel, and wherein the first threshold value is modifiable.

7. The memory device according to claim 6, wherein the memory controller comprises the plurality of channels, the channel serving as an interface to be connected to the nonvolatile memory; and
wherein depending the size of the write data to be written on the physical block, the memory controller writes the data in one channel while erasing a plurality of blocks in another channel in parallel.

8. The memory device according to claim 1, wherein the erased physical block managing unit selects as a write block a block that is registered first as an erased block.

9. The memory device according to claim 1, wherein the erased physical block managing unit selects as a write block a block having the smallest erase count.

10. The memory device according to claim 8, wherein the memory controller comprises the plurality of channels, the channel serving as an interface to be connected to the nonvolatile memory;
wherein each channel includes at least two physical blocks unallocated to the logical address space, each physical block serving as the erase unit of the nonvolatile memory; and
wherein the memory controller does not select as a write block a physical block erased immediately before.

11. The memory device according to claim 10, wherein if the size of read data per block is larger than a second threshold value during data reading, the memory controller, while reading the data, searches an erasable physical block list and erases an erasable physical block belonging to a channel not used in the data reading.

12. The memory device according to claim 11, wherein the second threshold value of the size of the read data is modifiable.

13. The memory device according to claim 1, wherein the memory controller further comprises at least one channel, the channel serving as an interface to be connected to the nonvolatile memory;
wherein a plurality of nonvolatile memories are connected to one channel, and are sorted into a plurality of groups;
wherein each group includes at least one physical block unallocated to the logical address space;
wherein the erased physical block managing unit manages the erased physical block address, the group of the erased physical block address, and the erased physical block count on each group;
wherein the erasable physical block managing unit manages the erasable physical block address, the group of the erasable physical block address, and the erasable physical block count on each group;
wherein when data are received, the erased physical block managing unit allocates a physical block belonging to a group having a larger erased physical block count, as the first physical block corresponding to the logical address;
wherein in response to the received data, the erasable physical block managing unit selects a physical block belonging to a group not serving as a write destination, as the second physical block to be erased; and
wherein in response to the received data, the memory control unit erases the second physical block while writing the received data on the first physical block in parallel.

14. The memory device according to claim 1, wherein the memory controller further comprises at least one channel, the channel serving as an interface to be connected to the nonvolatile memory;
wherein a plurality of nonvolatile memories are connected to one channel, and are sorted into a plurality of groups;
wherein each group includes at least one physical block unallocated to the logical address space;
wherein, on a per channel basis, the erased physical block managing unit manages the erased physical block address, the group of the erased physical block address, and the erased physical block count on each group;
wherein, on a per channel basis, the erasable physical block managing unit manages the erasable physical block address, the group of the erasable physical block address, and the erasable physical block count on each group;
wherein when data are received, the erased physical block managing unit allocates a physical block belonging to a group not serving as an erase target, as the first physical block corresponding to the logical address;
wherein in response to the received data, the erasable physical block managing unit selects a physical block belonging to a group having a larger erasable physical block count, as the second physical block to be erased; and
wherein in response to the received data, the memory control unit erases the second physical block while writing the received data on the first physical block in parallel.

15. The memory device according to claim 1, wherein the memory controller further comprises:
at least one channel, the channel serving as an interface to be connected to the nonvolatile memory, a plurality of nonvolatile memories being connected to one channel, and sorted into a plurality of groups, each group including at least one physical block unallocated to a logical address space; and
a last-write group recorder configured to record information of the group having undergone last writing;
wherein, on a per channel basis, the erased physical block managing unit manages the erased physical block address, and the group of the erased physical block address;
wherein, on a per channel basis, the erasable physical block managing unit manages an erasable physical block address, and the group of the erasable physical block address;
wherein when data are received, the last-write group recorder checks a group having undergone preceding writing;
wherein in response to the received data, the erased physical block managing unit allocates a physical block belonging to a group having undergone no preceding writing, as the first physical block corresponding to the logical address;
wherein in response to the received data, the erasable physical block managing unit selects a physical block belonging to a group having undergone the preceding writing, as the second physical block to be erased; and
wherein in response to the received data, the memory control unit erases the second physical block while writing the received data on the first physical block in parallel, and subsequent to the data writing, the memory control unit notifies the last-write group recorder of information relating to the group having undergone the data writing.

16. The memory device according to claim 13, wherein the memory controller, in response to a write request exceeding the boundary of a size of the physical block received from a host apparatus, reselects a physical block to be erased and a physical block as a write destination below or beyond the boundary.

17. The memory device according to claim 16, wherein if the size of write data to the physical block is larger than a third threshold value, the memory controller writes the data in one group while erasing a block in another channel, and wherein the third threshold value is modifiable.

18. The memory device according to claim 13, wherein depending on the size of write data on the physical block, the memory controller writes the data in one group while monitoring a progress of the erasing in another group, and upon completion of the erasing, the memory controller issues an erase command to an address on another block.

19. The memory device according to claim 13, wherein the erased physical block managing unit selects as a write block a block that is registered first as an erased block.

20. The memory device according to claim 13, wherein the erased physical block managing unit selects as a write block a block having the smallest erase count.

21. The memory device according to claim 19, wherein the memory controller comprises at least two physical blocks unallocated to the logical address space, each physical block serving as the erase unit of the nonvolatile memory; and
wherein the memory controller does not select as a write block a physical block erased immediately before.

22. The memory device according to claim 21, wherein if the size of read data per block is larger than a fourth threshold value during data reading, the memory controller, while reading the data, searches an erasable physical block list and erases an erasable physical block belonging to a group not used in the data reading.

23. The memory device according to claim 22, wherein the fourth threshold value of the size of the read data is modifiable.

24. The memory device according to claim 1, wherein the memory controller comprises a plurality of channels;
wherein the plurality of channels are independently controlled; and
wherein each channel is connected to at least two nonvolatile memories.

25. A memory system comprising:
a plurality of nonvolatile memories configured to be erased at updating of data;
a memory controller configured to control the nonvolatile memory; and
a host apparatus configured to instruct the memory controller to at least write data,
wherein the memory controller includes
an address conversion table configured to convert a logical address specified by at data writing into a physical address of the nonvolatile memory;
an erased physical block managing unit configured to manage an erased physical block address, the nonvolatile memory of the erased physical block address, and an erased physical block count on each nonvolatile memory;
an erasable physical block managing unit configured to manage an erasable physical block address, the nonvolatile memory of the erasable physical block address, and an erasable physical block count on each nonvolatile memory; and
a memory control unit configured to control writing and erasing on the plurality of nonvolatile memories;
wherein at least one physical block on each nonvolatile memory remains unallocated to a logical address space with each physical block serving as an erase unit of the nonvolatile memory; and
wherein when data is received from the host apparatus, the memory control unit writes the received data on a first physical block of one nonvolatile memory managed by the erased physical block managing unit while, in parallel with the writing, erasing a second physical block of another nonvolatile memory managed by the erasable physical block managing unit.
